(19) United States
(12) Patent Application Publication
(10) Pub. No.: US 2002/0178447 A1
(43) Pub. Date: Nov. 28, 2002

(54) Behavioral targeted advertising

(76) Inventors: Michael A. Plotnick, Southampton, PA (US); Charles A. Eldering, Doylestown, PA (US); Douglas J. Ryder, Doylestown, PA (US)

Correspondence Address: EXPANSE NETWORKS, INC., 300 NORTH BROADSTREET, DOYLESTOWN, PA, 18901, US

(21) Appl. No.: 10/116,692

(22) Filed: Apr. 3, 2002

Related U.S. Application Data
(60) Provisional application No. 60/281,037, filed on Apr. 3, 2001.
(60) Provisional application No. 60/329,992, filed on Oct. 17, 2001.

(51) Int. Cl. H04N 5/445; H04N 7/10; H04N 7/173

(52) U.S. Cl. 725/36; 725/42; 725/46; 725/87

(57) ABSTRACT

Personal video recorders offer the ability to insert targeted ads to the subscriber locally where the interactions of the subscriber can be monitored. The order in which ads are inserted can be determined by an ad queue that is stored on the PVR. The order in which the ads are inserted can be modified based on the interaction of the subscriber. The modifications of the order may be defined in the ad queue where the ad queue contains links associated with specific actions or sets of actions. The modification may also been done by the PVR, where the PVR processes the interactions and modifies the ad queue based on applying some rules to the processed interactions.

### CROSS-REFERENCES

This application claims priority under 35 U.S.C. §119(e) for Provisional application No. 60/281,037, filed on Apr. 3, 2001 entitled “Personal Video Recorder (PVR) Market Overview and Advertising Opportunities” (Docket No. T738-00) and No. 60/329,992, filed on Oct. 17, 2001 entitled “Personal Video Recorder (PVR) System Requirements and Specification” (Docket No. T738-01). Both of the aforementioned applications are herein incorporation by reference, but are not admitted to be prior art.

This application is related to all of the Applicants co-pending applications, patents and publications listed below. Each application listed below is herein incorporated in its entirety but is not admitted to be prior art:

U.S. application Ser. No. 09/204,888, filed on Dec. 3, 1998 entitled “Subscriber Characterization System” (Docket No. T702-00);

U.S. patent application Ser. No. 09/516,983, filed on Mar. 1, 2000 entitled “Subscriber Characterization with Filters” (Docket No. T702-02);

U.S. patent application Ser. No. 09/591,577, filed on Jun. 9, 2000 entitled “Privacy-Protected Advertising System” (Docket No. T702-03);

U.S. patent application Ser. No. 09/635,252, filed on Aug. 9, 2000 entitled “Subscriber Characterization Based on Electronic Program Guide Data” (Docket No. T702-04);

U.S. patent application Ser. No. 09/857,256, filed on Dec. 2, 1999 entitled “Subscriber Characterization and Advertisement Monitoring System” (Docket No. T702-15);

U.S. application Ser. No. 09/205,653, filed on Dec. 3, 1998 entitled “Client-Server Based Subscriber Characterization System” (Docket No. T703-00);

U.S. application Ser. No. 09/205,119, filed on Dec. 3, 1998 entitled “Advertisement Monitoring System” (Docket No. T704-00);

U.S. application Ser. No. 09/516,314, filed on Mar. 1, 2000 entitled “Advertisement Monitoring and Feedback System” (Docket No. T704-01);

U.S. application Ser. No. 09/452,893, filed on Dec. 2, 1999 entitled “Subscriber Identification System” (Docket No. T705-01);

U.S. patent application Ser. No. 09/635,253, filed on Aug. 9, 2000 entitled “Subscriber Identification Based on Electronic Program Guide Data” (Docket No. T705-02);

U.S. application Ser. No. 09/857,160, filed on Dec. 2, 1999 entitled “Subscriber Identification System” (Docket No. T705-13);

application Ser. No. 09/553,637, filed on Apr. 20, 2000 entitled “Advertising Management System for Digital Video Streams” (Docket No. T708-01);

U.S. Patent Application number 10/031,268, filed on Apr. 20, 2000 entitled “Advertising Management System for Digital Video Streams” (Docket No. T708-13);

U.S. patent application Ser. No. 09/796,339, filed on Feb. 28, 2001 entitled “Privacy-Protected Targeting System” (Docket No. T715-10);

PCT Application PCT/US01/06650, filed on Feb. 28, 2001 entitled “Privacy-Protected Targeting System” (Docket No. T715-10PCT);

PCT Application PCT/US01/27217, filed on Aug. 31, 2001 entitled “Targeted Advertising at the Set-Top Box” (Docket No. T721-10PCT);

U.S. patent application Ser. No. 09/658,204 filed on Sep. 8, 2000 entitled “Targeted Advertising Through Electronic Program Guide” (Docket No. T723-00);

U.S. patent application Ser. No. 09/749,255 filed on Dec. 27, 2000 entitled “Scheduling and Linking IPG Ads in Conjunction with Programming Ads in a Television Environment” (Docket No. T727-10);

PCT Application PCT/US01/31682 filed on Dec. 27, 2000 entitled “Scheduling and Linking IPG Ads in Conjunction with Programming Ads in a Television Environment” (Docket No. T727-10PCT)

U.S. patent application Ser. No. 09/680,622 filed on Oct. 6, 2000 entitled “Method and System for Addressable and Program Independent Advertising During Recorded Programs” (Docket No. T728-10);

U.S. patent application Ser. No. 09/751,349 filed on Dec. 28, 2000 entitled “Inserting Local Signals During MPEG Channel Changes” (Docket No. T730-10);

U.S. patent application Ser. No. 09/998,979 filed on Oct. 31, 2001 entitled “Profiling and Identification of Television Viewers” (Docket No. T734-10);

U.S. patent application Ser. No. 10/006,874 filed on Nov. 14, 2001 entitled “Alternative Advertising in Pre-Recorded Media” (Docket No. T738-10);

U.S. Patent Application number Unknown filed on Apr. 3, 2002 entitled “Universal Ad Queue” (Docket No. T738-20);

U.S. Provisional Application No. 60/281,196, filed on Apr. 3, 2001 entitled “Subscriber Selected Advertisement Display and Scheduling” (Docket No. T740-00);

U.S. patent application Ser. No. 09/928,024 on Aug. 10, 2001 entitled “Targeting Ads to Subscribers based on Privacy Protected Subscriber Profiles” (Docket No. T741-10); and

PCT Application PCT/US01/25261, filed on Aug. 10, 2001 entitled “Targeting Ads to Subscribers based on Privacy Protected Subscriber Profiles” (Docket No. T741-10PCT).

### BACKGROUND OF THE INVENTION

The Video Cassette Recorder (VCR) is an integral part of most households. According to Statistical Abstracts of the United States, as of 1998 98.3% of US households had at least one television (the average number of television sets per home was 2.4) and 84.6% of TV households had at least one VCR. The Personal Video Recorder (PVR) is a term that is generally used to describe the digital equivalent of the VCR. PVRs are also known as Digital Video Recorders (DVRs) and when located outside of the residence can also be referred to as Personal Video Channels (PVCs).

Because VCRs are so universally accepted, it is clear that a digital successor technology will eventually take hold. That digital successor technology will provide the functionality of the VCR but with the added flexibility of a digital platform. The advent of the Internet will also have a significant impact on the successor technology to the VCR because Internet based delivery, storage and in-home distribution of multimedia content will allow for new PVR functionality and architectures.

VCRs have a fast-forward capability that allows the user to fast-forward through programming. One of the primary uses of the fast-forward button is to skip commercials in pre-recorded material. That is, users who have gone through the trouble to pre-record a program typically have no interest in viewing the advertisements. Because the use of VCRs to record programming for home use is considered “fair use” in terms of copyright, programmers and advertisers cannot prevent manufacturers from supplying VCRs or putting fast-forward functionality on VCRs, nor can they prevent consumers from using the fast-forward button to skip commercials.

PVRs, like the predecessor VCR, will have a fast-forward capability. Some manufacturers have even gone so far as to put a “commercial skip” button on the PVR that allows the user to completely skips over the advertisement with the touch of a button. Although there are copyright issues that may ultimately prevent the PVR manufacturer from including an explicit “commercial skip” button, PVR users will likely insist on the ability to fast-forward through commercials.

While it is possible that subscribers will skip all commercials it is more likely that they will skip only the ads that they are not interested in. Thus, there is a need to take advantage of the inherent feedback that is captured within the PVR to better target ads to the subscriber. There is also a desire to better coordinate the display of ads to the subscriber based on the inherent feedback.

### SUMMARY OF THE INVENTION

The present invention discloses a method and apparatus for dynamically presenting ads to subscribers based on the subscribers interactions to previous ads. According to one embodiment of the invention, the ads are selected from the ad queue (or universal as queue) stored in a personal video recorder (PVR) and the selection is behavioral in nature. That is, depending on how the subscriber reacts (or interacts) to the ads presented to them determines what ads are displayed to the subscriber (behavioral targeting). The reactions (or interactions) to the ads may include viewing the ads, skipping the ads, fast forwarding the ads, changing the channel, viewing an alternative ad, requesting more information about the product, service or company in the ad, or other reactions that would be known.

According to one embodiment, the behavioral aspect is included in the ad queue (or UAQ) as some type of tree structure defined therein. Based on whether the subscriber watches or skips each ad determines the next ad that is displayed to the subscriber. The next ad selected from the ad queue (and presented to the subscriber) if the subscriber views the ad may be have a common parameter with the viewed ad. The common parameters may include, but are not limited to, similar intended market demographics, shared product/service type, same ad type, same ad genre, same company, similar features, and other parameters that would be obvious to one of ordinary skill in the art. The next ad selected if the ad is skipped may have different parameters than those for the skipped ad.

The choice of which parameter to use or not use for the next ad is subjective. That is, the parameter that the next ad is based on (related/not related to) may be specific ad, ad type, ad genre, product, service, company, other criteria, or a combination thereof. The parameter used will depend at least some subset of criteria used by the advertisers in selecting their ad campaign and criteria used by the delivery network in generating the ad queue (or UAQ). The criteria used by the delivery network may include, but is not limited to, subscriber preferences, market segment associated with the subscriber, previous interactions of the subscriber, subscriber viewing habits, or some combination thereof.

The tree structure would not be limited to view and skip, but could also include fast-forward, change channel, turn up/down volume, or other reactions that would be obvious to one of ordinary skill in the art. The tree structure defined in the ad queue may be tight or loose. A tight ad tree would be one that specified the next ad in the queue based on a specific action. A loose ad tree would be one in which the next ad is not necessarily selected based on a single action. That is, the next ad may be based on a multitude of actions, or the next ad may be based on the which is the next ad with a certain feature. The tree structure need not make a determination after each ad but may make a determination after a set of ads. The decision may be based on whether a majority of the ads where watched or skipped, or whether a certain number were watched or skipped. If the ads were a set of ads, there could be more criteria than simply watched or skipped. For example the criteria could be what percentage of ads were watched and there could be 4 separate paths (0-25%, 25-50%, 50-75%, and 75-100%).

As it is possible that a single ad may be displayed based on totally separate branches, in a preferred embodiment, the selection of the next ad in the tree (ad queue) should not be limited to simply the subscriber interaction to that ad but should be based on a track record of decisions. The more ads that are monitored, the more accurate the selection of the next ad will be, as there will be more data to base the determination on. According to a preferred embodiment, the interactions to the ads will be monitored and processed so that there is a composite description of the subscriber ad preferences to use in making the determination as to which ad to display next.

According to one embodiment, the decsion tree is not associated with the ad queue (or UAQ). Rather, the ad queue may be modified based on the actions of the subscriber. That is, the PVR may learn about the subscriber and modify the UAQ to be more in line with the subscriber. The modification of the UAQ may be based on rules associated with the subscriber's actions. The rules may be rules provided by the advertisers in the development of the UAQ, general rules applied to all UAQs, rules that are based on a profile of the subscriber developed by the PVR, other types of rules now known or later developed, or some combination thereof. The rules may modify the order of the UAQ, may remove ads from the UAQ, may add ads to the UAQ, may add limitations (preferences/restrictions/links) to the UAQ, or make other modifications that would be obvious to those of ordinary skill in the art. The rules may be applied after each ad, after each specific action a subscriber takes while viewing an ad (i.e., skip or fast forward ad, change channel, raise or lower volume), at fixed intervals (i.e., once a day), when the PVR determines that it is in order, or some combination thereof.

These and other features and objects of the invention will be more fully understood from the following detailed description of the preferred embodiments that should be read in light of the accompanying drawings.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIG. 1 illustrates an exemplary system diagram of a Personal Video Recorder (PVR);

FIG. 2 illustrates an exemplary system diagram of a Video-on-Demand (VoD) network;

FIG. 3 illustrates an exemplary system diagram of a Personal Video Channel (PVC) head-end based PVR network;

FIG. 4 illustrates an exemplary context diagram of a client side set-top box (STB) ad targeting system;

FIG. 5A illustrates a single ad queue structure for multiple market segments/subscribers;

FIG. 5B illustrates the use of multiple ad queues for multiple market segments/subscribers;

FIG. 6 illustrates an exemplary universal ad queue. (UAQ);

FIG. 7 illustrates an exemplary context diagram of a server side ad management system;

FIG. 8 illustrates an exemplary block diagram for a client side STB ad targeting system;

FIG. 9 illustrates an exemplary block diagram of a server side ad management system;

FIG. 10 illustrates an exemplary data flow in a PVR-enabled set-top box for delivering targeted advertising;

FIG. 11 illustrates an exemplary data flow in an ad management system designed to deliver targeted advertisements to a PVR-enabled set-top box;

FIG. 12 illustrates an exemplary use of dynamic ad presentation using structured ad queues, wherein the selection of ads is based on behavioral targeting;

FIG. 13 illustrates an exemplary ad queue with tight behavioral links; and

FIG. 14 illustrates an exemplary ad queue with loose behavioral links.

### DETAILED DESCRIPTION OF THE PREFERRED EMBODIMENT

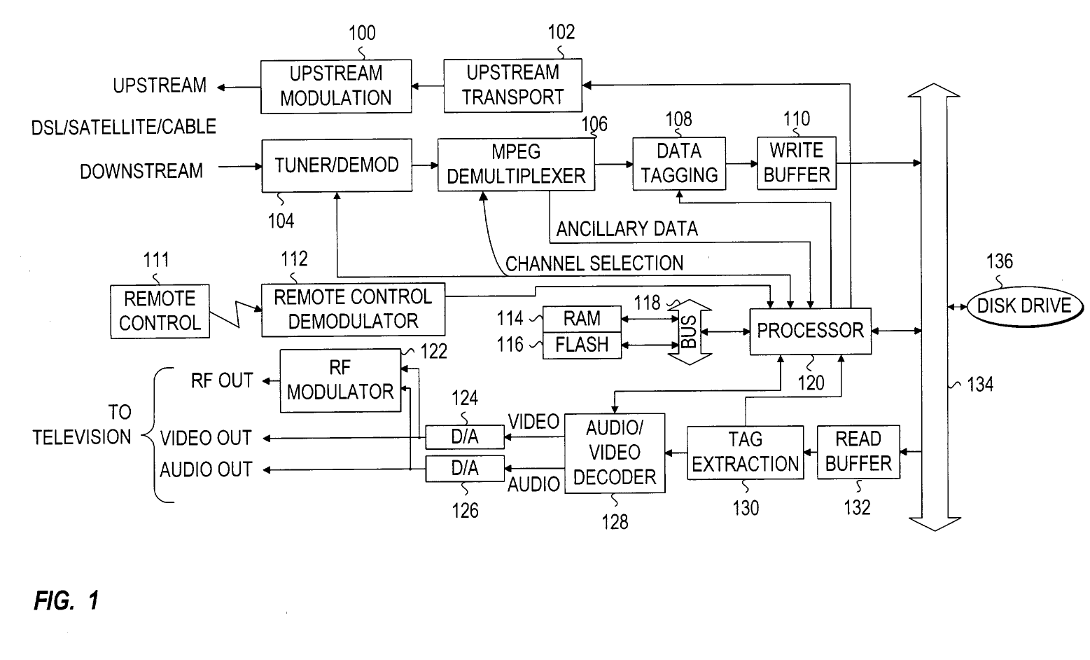

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose. With reference to the drawings, in general, and FIGS. 1 through 14 in particular, the method and apparatus of the present invention are disclosed.

A personal video recorder (PVR) is a device that enables a television or other interactive media viewer the ability to digitally store programming for subsequent viewing. PVRs may also be referred to as Digital Video Recorders (DVRs) and in some instances (in particular head-end based PVRs) are referred to as Personal Video Channels (PVCs). When used herein the term PVR refers to any type of device which digitally stores and plays back programming, and can include devices located in the residence, the head-end or central office, in the distribution network, as part of the Internet, or distributed over any or all of these locations.

Streaming media may begin to change the way video is viewed in the home and new Internet based interfaces for television viewing may appear. These advances will facilitate PVRs and may result in new types of PVR based systems which are essentially Internet based networks in which information is stored and managed in a distributed manner between the content provider, service provider, and viewer.

The PVR provides the basic functions of a VCR including record, play, rewind and fast-forward. The PVR also includes functions that give a viewer the ability to manipulate live television programs by recording them simultaneously as they are being watched. This allows the viewer the ability to “pause” and have the program be recorded automatically (without hitting a Record button) and then resume watching the program by hitting Play. PVRs used to watch live programming allow the viewer to fast-forward up to the current time, such that if pause was hit the viewer can return to the programming and advance through what was stored during the pause. Fast forward speeds typically include 5×, 20×, and 60×, but are clearly not limited thereto. PVRs can also offer the ability to convert live program to a recording (“Convert to Recording” feature) the ability to return to live viewing (“Resume Live TV” feature) and the ability to clear the recording buffer upon a channel change.

Regardless of how a program was recorded on the PVR, during playback the PVR offers the viewer the ability to play, stop, pause, rewind, and fast-forward through the recorded program. In addition, the digital PVR can support frame forward and frame backward features as well as digital slow motion, bookmark, and “go to time” features. An additional, and controversial, feature is the “Skip Forward” or “Commercial Skip” function, which some commercially available devices offer. Theses functions allow a user to skip forward exactly 30 seconds, effectively allowing the viewer to skip through commercials without seeing any portion of the advertisement or having to search for the return to programming. Clearly this feature will greatly reduce the effectiveness of television advertising, and could potentially eliminate traditional advertising entirely. A variety of advertising techniques are likely to be used based both on traditional 30-second spots as well as on novel advertising methodologies that will deliver the message to the viewer even though they have the ability to quickly skip through advertisements.

The manual recording features on a PVR are similar to those on a VCR, but PVRs also include advanced features such as the ability to check for schedule conflict and to set recording quality, priority, and expiration (the point in time at which the program is deleted from storage). Program guides, often referred to as Electronic or Interactive Program Guides (EPGs/IPGs), will generally be available on PVRs and are a key feature in that they allow the user to find programs that they wish to watch or record, as well as providing ancillary information about the programs. The program guide information can also include metadata about the programs that enables the autonomous recording of programs based on a user profile. Automatic program guide based recording can be used to record or repeatedly record a program. Some PVRs provide for intelligent recording in that they will automatically record programs based on a user having recorded or watched that program previously. Some systems also attempt to “learn” what the user likes to watch and will record those programs as well as similar programming. An example of a system which learns user preferences for future recording is described in World Intellectual Property Organization (WIPO) publication WO 99/65237 entitled “Television programming recording with user preference determination,” published on Dec. 16, 1999.

The PVR may be a standalone unit or may be integrated into a cable or satellite set-top box (STB). A variety of output formats can be supported including analog S-video and composite video formats. Digital outputs may be supported (e.g. IEEE 1394 which is herein incorporated by reference) and the PVR may form part of an in-home network or distributed media storage and playback network. Applicants' co-pending provisional applications previously incorporated by reference (but not admitted to be prior art) and identified by docket numbers T738-00 and T738-01 provide additional descriptions of PVR functionality.

FIG. 1 illustrates an exemplary system overview of a PVR-enabled set-top box (STB PVR) or residential gateway (RG) that contains the basic functionality necessary to support upstream and downstream data transmission, digital television reception and presentation, and storage of digital video programming. The system contains a tuner/demod 104 that provides for the reception of programming and data. In some systems (such as cable systems) multiple demodulators may be used to provide simultaneous delivery of digital video/audio (MPEG) and Internet Protocol (IP) data. An MPEG demultiplexer 106 selects (filters) a single program from a multiple program stream. The MPEG demultiplexer 106 may contain a transport stream demultiplexer, Program Identifier (PID) filters, and a conditional access system. A data tagging unit 108 adds metadata descriptors to video to be recorded. The metadata is used by the PVR to identify and characterize programs. A write buffer 110 buffers video to accommodate disk access.

An upstream transporter 102 prepares data including the steps of packetizing, error protection, and other transport related functions. An upstream modulator 100 performs modulation and serves as the access protocol manager. As with most set-tops or televisions, a remote control 111 works in conjunction with a remote control demodulator 112 to allow remote control and programming of the PVR unit. A processor 120 runs middleware, PVR control software, and targeted advertising software. An actual implementation may use more than a single processor. As an example, one processor may be used to manage the core hardware resources, while a second processor may be used to handle middleware and PVR operations.

Random Access Memory (RAM) 114 and flash memory 116 are connected to processor 120 via a processor bus 118. Storage of programming is provided using a disk drive 136 although other types of high-capacity non-volatile memories may be used including memory sticks, write-read optical memories, or other magnetic, electronic, optical, magneto-optical, electro-optical or acousto-optical storage systems. The disk drive 136 is connected to the write buffer 110, processor 120, and a read buffer 132 through a system bus 134. The read buffer 132 buffers video to accommodate disk access. A tag extraction system 130 extracts metadata descriptors from recorded video. An audio/video decoder 128 decodes digital video and audio, examples of which are MPEG video and MPEG/AC-3 audio. The video D/A 124 and audio D/A 126 convert video and audio signals respectively to analog signals that can be sent directly to S-video or RGB inputs on a television or to an RF modulator 122 which can modulate the signals onto an appropriate TV channel.

As previously discussed, the PVR may be connected to a variety of networks including a cable network which supports one or more digital video and/or data protocols including any of the Motion Picture Expert Group (MPEG) video standards and the Data Over Cable Interface Specification (DOCSIS) protocol. The PVR may alternatively receive signals from a satellite and can potentially be connected to the Internet (for return signals) via a telephone line or other network connection. In the satellite embodiment, the PVR can receive advertisements from the satellite network or potentially over the telephone line or other network connection. The telephone line or other network connection can be utilized to report back viewing statistics and ad viewing information. In another embodiment, signals are sent back through the satellite or via a land based wireless connection.

In a DSL embodiment, the PVR is connected to a telephone line which supplies video signals and which can simultaneously serve as a data network for two-way communication with the PVR. For Internet based video, the PVR can be connected over a variety of network types and can receive streaming media broadcasts. The signals may be unicast or multicast and can be delivered from a centralized server, a distributed server system, or via an edge network. PVRs can also be used with broadcast (over-the-air) networks and microwave “wireless cable” systems. When used in conjunction with these delivery systems, an appropriate return path (either telephone, cable or other network connection) can be used to provide two-way capability to the PVR.

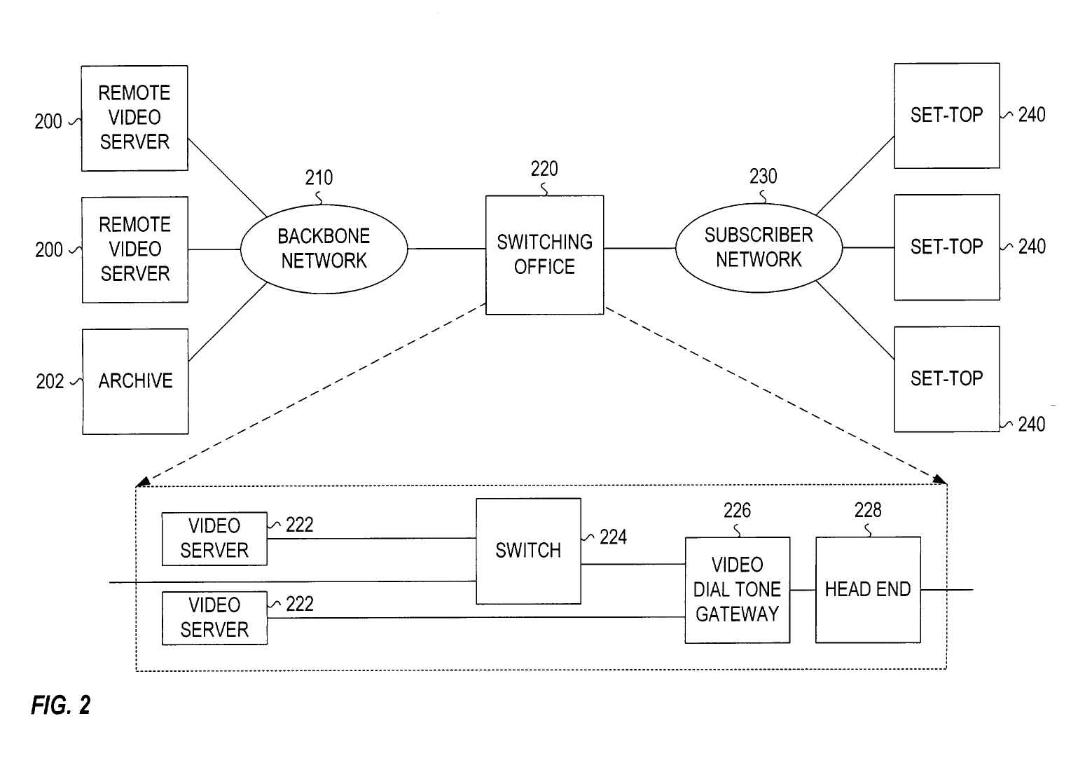

The ability to provide video programming to the consumer at the exact time that they desire that programming is known as Video on Demand (VoD). A VoD system allows a subscriber to retrieve video (i.e., a movie) at any time. A true VoD system also includes the ability to pause the movie, fast forward through the movie, rewind, or stop at any point in the programming. Thus, a VoD system is in effect a type of headend PVR. FIG. 2 illustrates an exemplary VoD system that includes remote video servers 200 that store video; an archive 202 that stores items such as infrequently viewed movies; a backbone network 210 that is used for the distribution of digital video from the remote video servers 200 to a switching office 220; a subscriber network 230 which connects the switching office 220 (more precisely head-end 228 within the switching office 220) to set-tops 240.

Within the switching office 220, various components are used to provide the VoD service including video servers 222, a switch 224, a video dial tone gateway 226 and the head-end system 228. The video servers 222 provide “local” or “edge” storage capability that allows video that is accessed more frequently to be stored closer to the subscriber than across the network on the remote video server 200 or archive 202. The switch 224 is used to direct traffic to the video dial tone gateway 226 that provides a subscriber interface as well as providing Operational Support Systems (OSS) and Traffic & Billing (T&B) functions. In operation, the video dial tone gateway 226 can present the subscriber with a menu for services which can guide the subscriber through the sources for video (content providers) and present the pricing information if the video is being sold on a per-unit basis (as opposed to a subscription service). The video dial tone gateway 226 thus insures that the subscriber can select the appropriate video content, that the content is accessed from the correct video server 200, 222 or the archive 202, that the head-end 228 and the set-top 240 are appropriately configured to transmit and receive the content respectively, and that billing records are created. Although the OSS and T&B systems are not illustrated in FIG. 2, they can be incorporated into the video dial tone gateway 226 or may be a separate system located in the switching office 220 or elsewhere in the network.

The head-end system 228 represents the set of equipment that is needed to deliver the advertisement over the specific delivery platform in the subscriber network 230. The subscriber network 230 may be a cable system based on Hybrid Fiber Coaxial (HFC) technology, a DSL network, or a land or satellite based wireless network. In the case of an HFC network, the head-end system 228 will typically multiplex a number of VoD streams together and modulate the multiplexed stream onto one or more Quadrature Amplitude Modulated (QAM) channels. For a HFC network, typically, there will also be a return channel that may consist of a DOCSIS based modem in the set-top 240 and corresponding Cable Modem Termination System (CMTS) in the head-end 228. The return channel transports requests and commands from the set-tops 240 to the head-end system 228. Alternative downstream modulation formats and return paths can be utilized.

In the case of a telephone type network based on DSL technology, the head-end system 228 can consist of a terminal such as a Broadband Digital Terminal (BDT) or Host Digital Terminal (HDT), which receives video signals and prepares them for transmission to field located distribution equipment in the subscriber network 230. The transmission is typically via a fiber optic connection and is done in stages in which the fiber carries a signal from the switching office 220 to a terminal located in the field such as a Universal Access Multiplexer (USAM) or Digital Subscriber Line Access Multiplexer (DSLAM). From this point in the network, the signals can be transported to the set-top 240 over twisted wire pairs using one of the DSL transmission technologies. Alternatively, the equipment in the network may be fiber optic based such that the transport to the home is entirely over a fiber optic connection, thus forming a Passive Optical Network (PON) or an optical Fiber to the Home (FTTH) network.

A distinction between the HFC network and the networks used by telephone service providers is that in the HFC network the bandwidth is typically shared between all of the subscribers on a cable node, whereas in a DSL network each subscriber has an individual connection with a pre-determined amount of bandwidth. This has an impact on the design and implementation of the head-end system 228, but should not affect the VoD functionality presented to the subscriber.

Satellite and land based wireless VoD systems will have head-end systems 228 which are yet distinct from cable and telephone network head-ends. Satellite systems can utilize a variety of return paths including satellite uplink, telephone line, Internet, or cable based. Both use sharing of the bandwidth on the downstream, with the satellite system extensively sharing bandwidth across the footprint of the satellite system. The VoD system can also be based on Internet Protocol (IP) and can use streaming media techniques, including unicast and multicast, to deliver the video across the backbone and subscriber networks (210 and 230 respectively) and to the set-top 240. Using the IP protocol allows for flexible delivery of the video, independent of the transmission technology in the subscriber network 230. The IP protocol will also provide for the ability to easily transport and store video within the home, thus supporting in-home networking and incorporation of the subscriber set-top 240 or personal computer into the VoD network.

The VoD system illustrated in FIG. 2 can be used to deliver video in various types of “on demand” formats including Quasi Video-on-Demand (QVOD) in which users are grouped based on a threshold of interest, and in which users can perform basic temporal control by switching to a different group. The system can also support Near Video-on-Demand (NVoD) in which functions like forward and reverse are simulated by transitions in discrete time intervals (e.g. 5 minutes). One mechanism for achieving this is to provide multiple versions of programming with small time skews between the versions. In true VoD services, the user has complete control over the session presentation including full-function digital VCR capabilities: play (forward and reverse), pause, fast-forward, rewind, and random position.

A head-end based PVR, also known as the Personal Video Channel (PVC), is an implementation of the PVR in which the storage function is performed outside of the subscriber residence. The PVC implementation makes use of the storage inherent to the VoD system to form and manage the PVR. One advantage of the PVC implementation is that the STB needs less functionality (i.e., no storage) and thus has a lower cost. One of the drawbacks of the PVC is that when the penetration of the PVC service reaches a certain point the cost of bandwidth to deliver the stored programming exceeds the cost to have individualized (residential) PVRs.

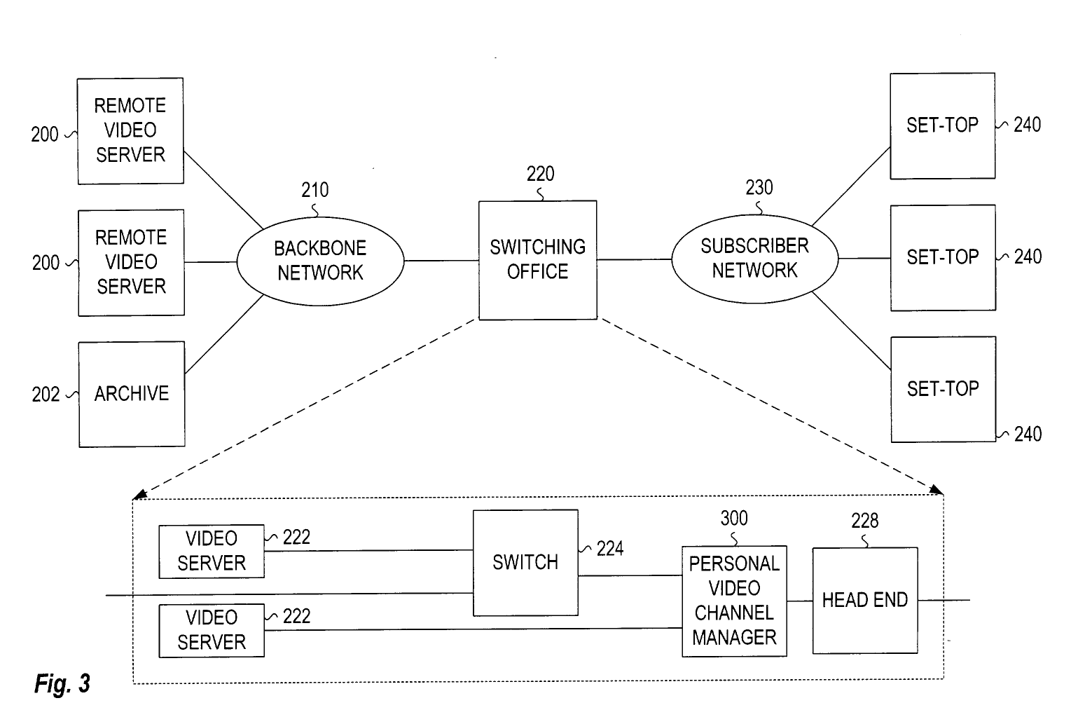

FIG. 3 illustrates an exemplary implementation of a HE PVR. In this embodiment, the video dial tone gateway 226 of FIG. 2 is replaced by a personal video channel manager 300. The personal video channel manager 300 provides the PVR functionality to subscribers by managing their stored programs and accessing the stored programming on command, just as in a VoD system. The principal distinction between the VoD system and the PVC is that in the PVC recording is enabled so that users can request that a particular program be stored. In the event that the programming is a live event and therefore not presently stored, the personal video channel manager 300 ensures that the programming is recorded on video server 222 or on another storage unit. If more than one user requests that a program be recorded, the personal video channel manager 300 notes that the program has already been recorded and can prevent additional copies from being made.

From an advertiser's perspective, the PVR offers a tremendous range of possibilities for directing advertisements, including traditional 30 second commercials, IPG ads, pre-pended and post-pended ads, as as well as various types of virtual ads (i.e., overlays, product placements, bugs). The digital storage medium can store a large number of ads in addition to the recorded programming. The basic functionality of the PVR will allow for the insertion and splicing of these ads into playback material. The ads stored in the PVR will be ads determined to be relevant to the household (and individuals within the household). The ads may be filtered prior to being received by the PVR or the PVR may itself act as the filtering mechanism.

The PVR may have the ability to profile viewers and identify which viewer (or group of viewers) is interacting with the TV. Based on the viewer profiles and/or viewer identification, the PVR can deliver specific (targeted) ads. The ability to profile viewers and to identify viewers in a household based on their viewing characteristics is described in Applicants' copending patent applications that have previously been incorporated by reference (but not admitted to be prior art) and identified by docket numbers T702-00, T702-02, T702-03, T702-04, T702-15, T703-00, T705-01, T705-02, T705-13, T721-10PCT, T734-10 and T741-10. The targeted ads may either be spliced into a live or prerecorded program, overlaid on a program, inserted into programming, or through other means that would be obvious to one of ordinary skill in the art.

The PVR can also report back viewing statistics and provide the advertiser information with respect to the effectiveness of the advertising (i.e., how many viewers are watching the ads and to what degree of completion). The advertiser can use the PVR to achieve one-to-one marketing capability by insuring that the right ads are delivered to and ultimately displayed to the right viewers. Although it is technically possible to learn about each viewer individually, privacy concerns and the well-established mass advertising techniques used by major advertisers are likely to result in a migration to one-to-one advertising on PVRs through the formation of market segments. In forming market segments advertisers specify characteristics of the viewers they want to reach. Although some of these characteristics may be related to viewing habits, it will ultimately be possible to generate a list of viewers (e.g. viewers coming off lease of a certain type or brand of vehicle in the next 6 months), have those viewers placed in a specific market segment, and deliver the ad to those viewers for subsequent display. To protect privacy the advertiser may not be provided with any user identifiable information, and in some cases will only know the number of individuals or households in the designated market segment. It is therefore possible to create very specific market segments without revealing personal information.

As previously mentioned, one potentially powerful way to advertise and direct ads on PVRs is through the substitution of (or manipulation of) traditional video ads (i.e., 30 second ad that appears in broadcast programming, ads that are pre-pended or post-pended in VoD programming). The PVR can substitute ads during live programming (play or recording of) or when pre-recorded programming (or VoD) is being played. Another opportunity for advertising on PVRs is through the program guides. The program guides provide graphical information regarding current and upcoming programming. Modem program guides (typically referred to as Interactive Program Guides or IPGs) have incorporated graphical advertising as part of the program guide. The ads that can be placed in the advertising portion of the IPG include static advertisements inserted in the IPG, video clips and streaming media played through the IPG, and combinations of static ads and video clips displayed in the IPG. Another advertising opportunity on the PVR is the display of ads when channel changes (can be considered a trick play event) are made or while information is being retrieved from the local hard drive or other server. In this embodiment, the channel change or pause can be considered trick play events. Applicants' copending patent applications previously incorporated by reference (but not admitted to be prior art) and identified by docket numbers T723-00, T727-10, T728-10, and T730-10 describe targeting advertisements in IPGs, recorded programming and during channel changes.

PVRs may also utilize virtual ads (a variety of ways to advertise products within the programming itself) as an additional advertising opportunity. Virtual ads include the superpositioning of an ad on a billboard, or substitution of one product label for another in the programming (also referred to as product placement). For example, an actor or actress may be holding a soda (e.g. Pepsi®) in a scene of a show and the original Pepsi® label can be replaced with a Coca-Cola® label. Techniques for performing virtual ad insertion including background overlays and product placement are well known to those skilled in the art and are described in U.S. Pat. Nos. 5,543,856; 5,627,915; 5,808,695; 5,892,554; 5,593,076; 6,100,925; and 6,184,937 all of which are herein incorporated by reference. Other types of virtual ads include graphical overlays and “bugs” similar to the network promo graphics which are superimposed on programming today. Applicants' co-pending applications previously incorporated by reference (but not admitted to be prior art) and identified by docket numbers T738-00 and T738-01 describe the use of virtual ads in more detail.

Stored ads offer the possibility of presenting ads to subscribers “on demand” such that the subscriber is presented with the option to view one or more ads and chooses to do so. These ads are stored on the recording medium and retrieved when the user requests the ad, either through a direct selection on a menu, or by indicating interest by clicking on an object in the programming or presented in a static ad. Stored ads and infomercials can be organized and presented by subject matter, and can be targeted to a household based on the preferences and demographics of the household. Stored ads let viewers browse ads which they have determined have a high entertainment value. In addition, a payment/incentive system can be created to encourage viewers to watch ads. One advantage of stored ads is that the ads/themes/products which are of interested to the household can be easily identified by monitoring which ads they select and how many times they select them. Applicants' co-pending application previously incorporated by reference (but not admitted to be prior art) and identified by docket number T740-00 describes the selection of ads in more detail.

Interactive ads can also be utilized to deliver advertising to subscribers. In the interactive ads a user may be prompted to indicate which ad he/she wants to watch and then may asked to interact with that ad. The advantage of interactive ads is that the user is participating in the ad, which is likely to have a significant and positive impact on recall. The interactive ad can also supply a vast amount of information to the viewer. In one embodiment, hyperlinks are presented in the ads which allow the user to access information from the Internet or stored on the hard drive.

As can be readily understood, having storage capability as part of the STB PVR or in a VoD/PVC system allows for tremendous flexibility in the delivery of advertising. Although the fast-forward feature may limit the value of traditional advertising, many new delivery mechanisms for advertising are being envisioned.

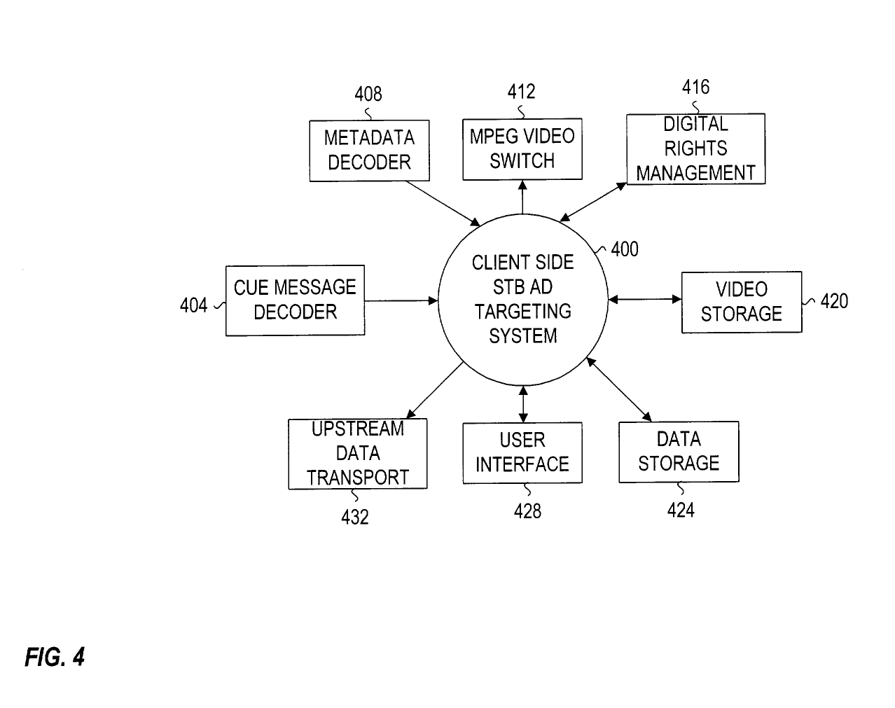

Because of the potential for delivering a variety of types of ads and the desire to target those ads, new management systems are required for advertising on PVRs. Ad queues form part of this ad management system and allow for the organization and presentation of different ads to different market segments and different subscribers. Ad queues can be best understood in the context of a client side set-top box targeting system 400 such as that illustrated in FIG. 4. The client side STB ad targeting system 400 is a software application that may be integrated into a PVR-enabled set-top box (STB PVR). The middleware package or the underlying operating system (OS) provides communication between the client side STB ad targeting system 400 and other components in the STB. The targeted advertising features of the client side STB ad targeting system 400 permit the device to analyze viewer behavior (shows watched, channel surfing habits, commercial watching, etc.), infer viewer profiles (demographic, psychographic, and behavioral attributes), select and present ads based on user profiles derived from one or more of the following: a demographic data obtained from a third party database, volunteered information, viewing characteristics, probabilistic determinations of demographics and interests generated by applying rules to viewing characteristics, an autonomous agent, or some combination thereof.

A cue message decoder 404 provides the functionality for decoding cue messages. Cue messages are embedded in network video feeds. They indicate the presence of ad opportunities (“avails”) for the insertion of ads. For digital-into-digital ad insertion systems, the cue messaging may be based on the SCTE DVS-253 standard that is herein incorporated by reference in its entirety. A metadata decoder 408 delivers all received metadata to the client side STB ad targeting system 400. The Metadata system may be based on the TV-Anytime Forum and MPEG-7 Metadata specifications. Metadata is data that is associated with a particular section of content that describes that content. Metadata includes descriptive items such as title, genre, cast, production company and production crew, language and other program related information. Metadata may also include the content's typical or intended demographic and psychographic groups.

An MPEG video switch 412 provides the functionality to seamlessly splice MPEG video/audio sequences. This function allows for clean insertion of ads. Splicing of MPEG video/audio sequences is well known to those skilled in the art. A digital rights management 416 component deals with the protection of the programming and ads to ensure that the content provider's copyright is adequately protected. This protection can include assurances that no unauthorized copies are made. A video storage 420 component is used to store all video/audio programs on the set-top box, including ads (commercials). The video storage 420 may be implemented using a mass storage device, such as a hard disk drive. Ad queues are used as part of or in conjunction with the video storage 420 to provide proper sequencing of ads. A data storage 424 component is used to store program metadata, profiles, and other data. Some part of the data storage 424 component may be non-volatile (survives power loss).

A user interface 428, typically implemented through on-screen graphics and a remote control or remote keyboard, facilitates all of the control and interactions with the television viewer. Some of the interactions will be used by the client side STB ad targeting system 400 to help build the viewer profiles necessary to do individual ad targeting. An upstream data transport 432 provides the service for sending data to the head-end system. The upstream data transport 432 works in conjunction with the hardware to send signals upstream over cable, twisted wire pair, wireless, fiber, or other connection.

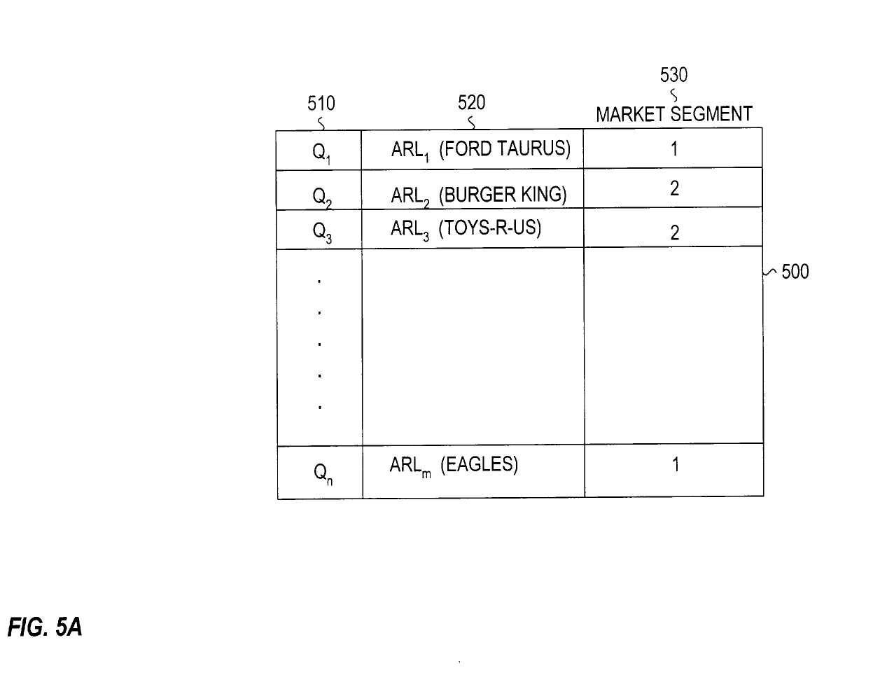

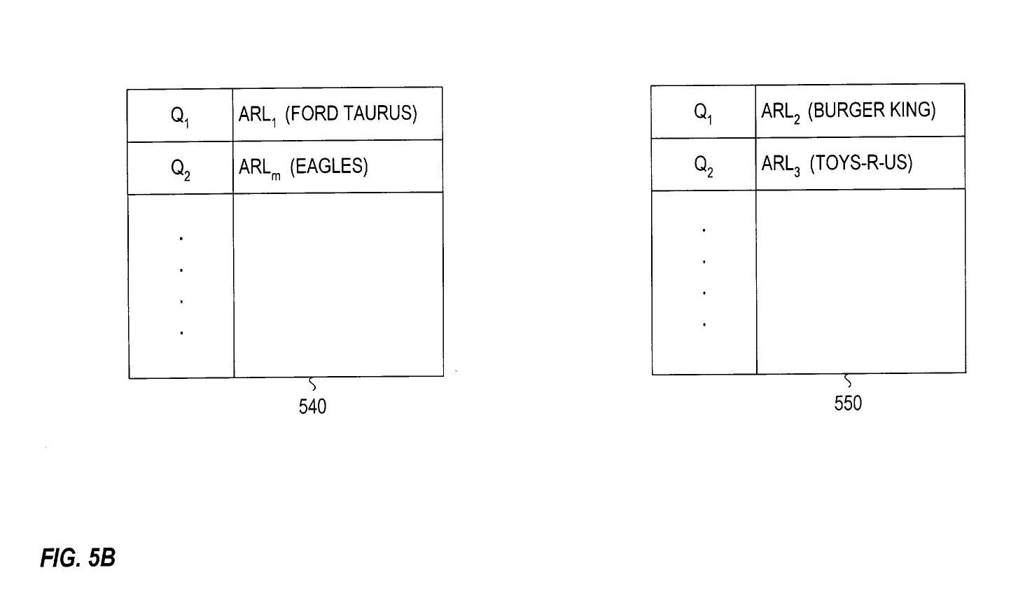

FIG. 5A illustrates a single ad queue 500 for multiple market segments/subscribers. The ad queue 500 is a data structure, which provides organization to the ads that are to be played. The ad queue 500 contains a number of slots 510 (Q₁ . . . Qₙ) and pointers or Ad Resource Locators (ARLs) 520 that indicate which ad is to be played. The ARL 520 can be in the form of a file name or may be an actual address on a hard drive. The ARL 520 can point to a locally stored ad or a remotely stored ad. The ad queue 500 may also include an identification of which market segment 530 the ad is directed. The ad queue 500 can be local within the STB or can be at the head-end. As illustrated, the ad queue 500 includes ARL1 indicating that a Ford Taurus® ad is to be played, ARL2 pointing to a Burger King® ad, ARL3 pointing to a Toys-R-Us® ad, and ARLm pointing to an Eagles ad. As illustrated, ARL1 is grouped with ARLm to form a first market segment and a second market segment is formed to include ARL2 and ARL3. The market segment 530 may represent a large group or may represent individual subscribers within a household. FIG. 5B illustrates an alternate embodiment in which separate ad queues are utilized to represent each market segment. As illustrated a first ad queue 540 stores the ads associated with the first market segment and a second ad queue 550 stores the ads that are associated with the second market segment.

FIGS. 5A-B simply illustrate exemplary ad queues and in no way are intended to limit the scope of the invention. The ad queues may be specific to program ads (for live programming or recorded programming) or may be specific to any other number of ads including, but not limited to, EPG ads, bugs, overlays, pre-pends, or post-pends. Moreover, the ad queue may define criteria that could change the order of the ads in the queue including at least some subset of day, time, channel or program. The ad queue may also link the display of certain type of ads to the display of certain other type of ads. For example, an EPG may be selected for display based on the programming ads that were displayed prior to the EPG activation. Any of the criteria or links in the ad queue may be positive (i.e., must play, preferred play) or may be negative (do not play, prefer not be played). The criteria and the links may also be weighted so that certain factors take precedence over other factors. There may be a separate ad queue for each type of ad or there may be a universal ad queue (UAQ) for all the various ad types. A UAQ need not mean a single ad queue that is located in one location, it may be any number of ad queues in any number of locations that are all linked together in some fashion so as to control the display of advertising to the subscriber.

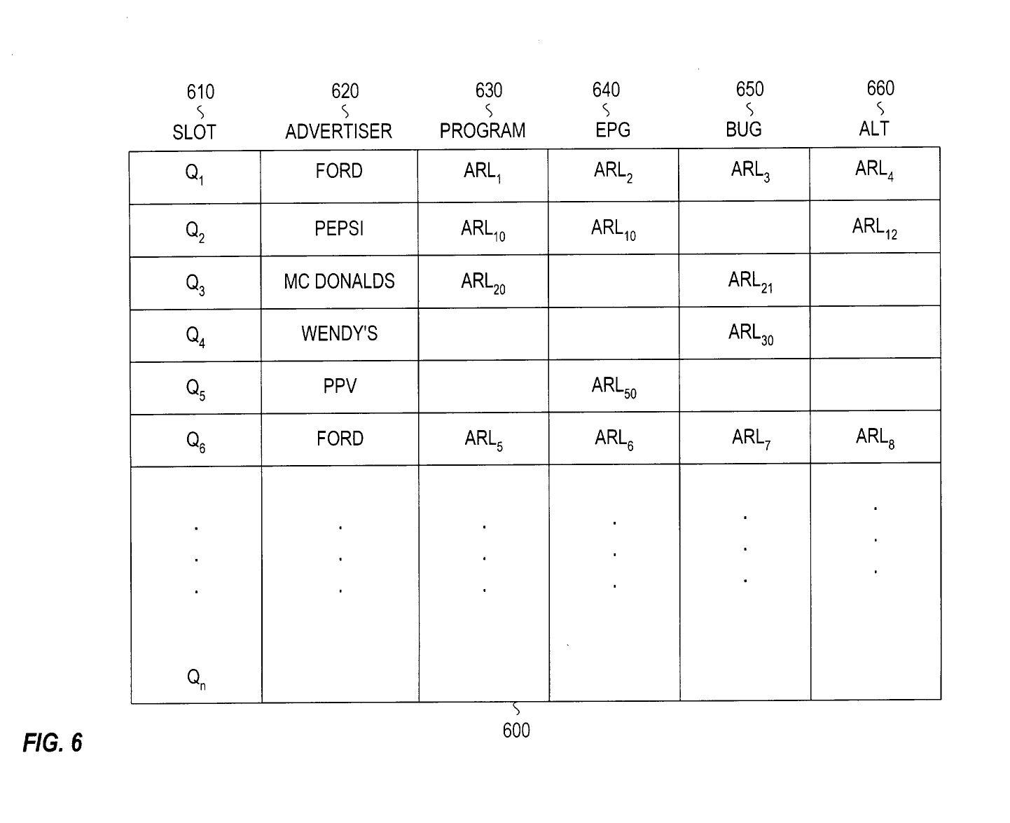

According to one embodiment, a UAQ may be an ordered list of ads to display that is not based (at least for the most part) on the type of avails. That is, for each advertiser the UAQ provides an ad for multiple ad types and based on the next avail the appropriate ad type is selected for that advertiser. FIG. 6 illustrates an exemplary UAQ 600 that has specific advertisers 620 associated with each slot 610 in the queue. Each advertiser 620 then has different ad types defined for the specific company, product, or service. As illustrated, the UAQ includes ARLs for programming ads (i.e., typical 30 second commercial) 630, EPG ads 640, Bugs 650, and alternative ads (to be discussed in more detail later) 660. The next ad to be inserted is based on the next available avail. For example, if the first avail is an EPG avail, the Ford® EPG ad will be retrieved from ARL2. In the case of Ford® (Q1), a Ford® ad would have been displayed regardless of the avail type. However, it should be noted that some advertisers will not have or want ads associated with certain avails. For example, Pepsi® (Q2) does not have a bug ad associated therewith. Thus, if Pepsi® was next in the queue but a bug avail was the next avail, Pepsi® would be skipped over and replaced with McDonalds® (Q3) as McDonalds® would have been next in the queue. The McDonalds® bug ad would then be retrieved from ARL21. Pepsi® would remain the top advertiser in the queue and a Pepsi ad® would be selected in the next avail that was not a bug avail.

As would be obvious, advertisers may exist multiple times in the queue. The placement of the advertisers in the queue may be random, may be based on all the different criteria provided for each advertiser, may be based on a formula (i.e., Qnew=Qold+5), or some combination thereof. For example, Ford® is in slot Q1 and slot Q6. As illustrated, all of the ad types associated with Ford® in Q6 are different than those in Q1. However, as one skilled in the art would recognize, the ads need not be new ads each time, some or all of the ad types may have the same ads. According to one embodiment, the only ad type that will have a new ad is if the ad type was displayed the previous time. As one of ordinary skill in the art would recognize there are numerous ways in which the ads associated with the different ad types for a particular advertiser can be managed within the UAQ that would be well within the scope of the current invention.

The exemplary embodiment of FIG. 6 is not intended to limit the scope of the invention. Rather, as one of ordinary skill in the art would recognize, the UAQ can be organized in multiple fashions, or be any size or structure without departing from the scope of the current invention. There can be any type of ads or combination of ads in the queue, the ads in the queue may be linked to other ads, other events, time or other criteria. The UAQ is not limited to a matrix as illustrated in the exemplary embodiment (FIGS. 6). The UAQ can be numerous other functional equivalents (i.e., a database) that would be within the scope of the present invention, as one of ordinary skill in the art would recognize. Applicants' co-pending patent applications that have previously been incorporated by reference (but not admitted to be prior art) and identified by docket numbers T721-10PCT and T738-20 disclose ad queues and the UAQ in more detail.

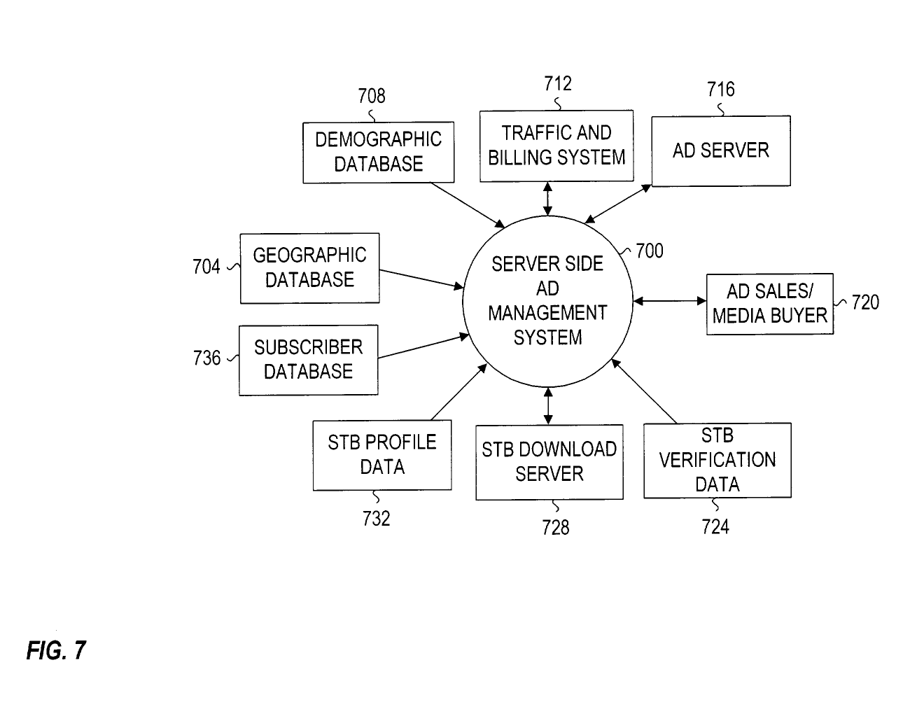

FIG. 7 illustrates an exemplary context diagram of a server side ad management system (AMS) 700. The server side AMS 700 contains a platform that manages the sales and distribution of television ads in the cable television, DSL, or satellite environments. The server side AMS 700 gives advertisers the ability to describe their ads in terms of target market demographics, required ad bandwidth, ad duration, and other ad specific parameters. The server side AMS 700 matches the ads to the advertising opportunities that occur in the package of programming either delivered to subscribers in real time or stored on the subscriber's PVR hard disk drive. In addition, the system will work with prepend/postpend ad opportunities in a VoD environment. The server side AMS 700 tracks avails including duration and bandwidth of the avail, and uses a number of algorithms to determine if the ad can be placed in the avail.

The targeted advertising features of the server side AMS 700 support and manage all of the head-end/CO activities required to facilitate the targeting of television adverting on PVR-enabled set-top boxes (STB PVRS). The functionality of the server side AMS 700 includes market segmentation, geodemographic database management, viewing statistics collection, profile aggregation, ad server content and distribution management, content metadata management, STB software management, interface to traffic and billing systems, and support of the ad sales process.

A geographic database 704 describes the subscriber area based on map information and other geographic sources. This information is used to create maps of the subscriber area indicating market segmentation. A demographic database 708 describes the basic demographic characteristics of the neighborhoods within the subscriber area. This information is used by the server side AMS 700 to establish baseline market segments for ad targeting. A subscriber database 736 includes identification, location, and services for each subscriber served. A traffic and billing system 712 is used by the service operator to provide support for the ad insertion process. The traffic and billing system 712 manages customer contracts and schedules, manages media and controls ad insertion equipment, reconciles verification lists from ad insertion equipment, creates affidavits and invoices, and helps ad sales staff with analysis and sales projections. An ad server 716 stores and distributes all of the ads for a particular set of subscribers. An ad sales/media buyer 720 includes the provider's ad sales professionals, the advertisers, their ad agencies, and media planners/buyers. All of these people use the server side AMS 700 to plan and implement a targeted advertising campaign.

STB profile data 732 may come from the profiling engine within the STB and is used by the server side AMS 700 to refine the ad targeting strategy and market segmentation. A STB download server 728 is responsible for maintaining the software for the STBs. A STB verification data 724 may come from the STB ad queue system and is used to verify that a particular ad was presented to a particular viewer. Applicants' co-pending patent applications previously incorporated by reference (but not admitted to be prior art) and identified by docket numbers T708-01 and T708-13 describe the AMS in more detail.

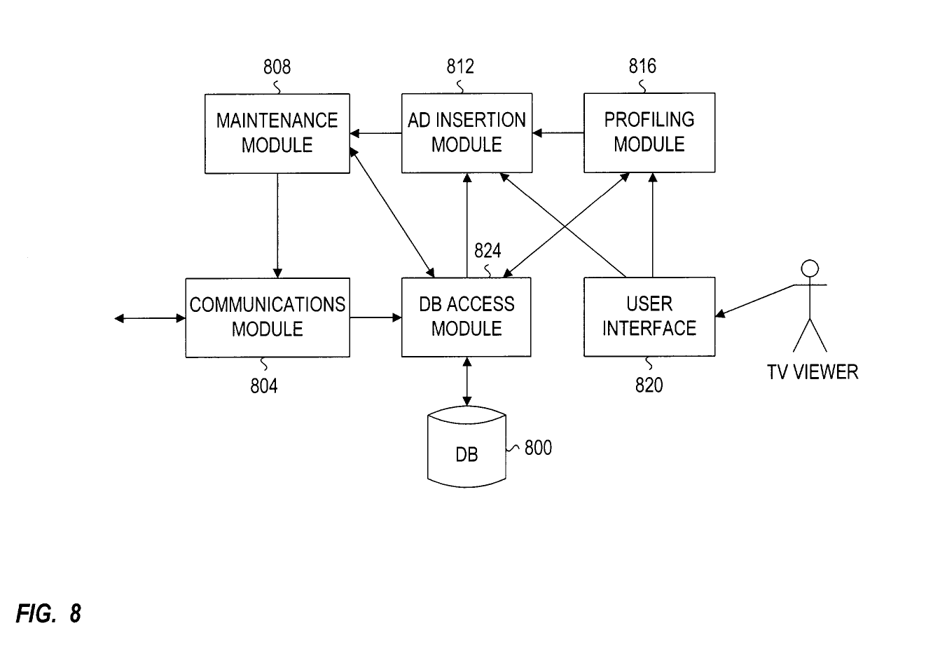

FIG. 8 illustrates an exemplary block diagram for the client side STB ad targeting system 400 of FIG. 4. A communications module 804 handles the interactions with the server side ad management system 700, uploading and downloading data as required for system operation. An ad insertion module 812 handles the processes necessary to incorporate targeted ads into television programs, including programs received in real-time or being played from the set-top box's hard disk. The ads may be inserted into the program material at indicated points or “avails” (through cue messages), or inserted before (pre-pended) or after (post-pended) a program. A profiling module 816 analyzes user actions and habits and infers demographic, psychographic, and behavioral characteristics of the viewing household and individual viewers. Applicants' co-pending patent applications previously incorporated by reference (but not admitted to be prior art) and identified by docket numbers T702-00, T702-02, T702-15, T703-00, T704-00, T715-10, T734-10 and T741-10 describe profiling in more detail.

A maintenance module 808 handles all maintenance of the ad queue and program table. A database module 800 stores information essential to the operation of the ad queuing and profiling system including viewer signatures, ad and program information (metadata), and possibly the ads themselves. A database access module 824 manages all access to the set-top database. The database access module 824 coordinates file system issues, multiple simultaneous requests, etc. A user interface (UI) module 820 receives input from the remote control keypad or keyboard associated with the set-top box, selects appropriate events, and directs these events to the proper destinations within the ad queuing system.

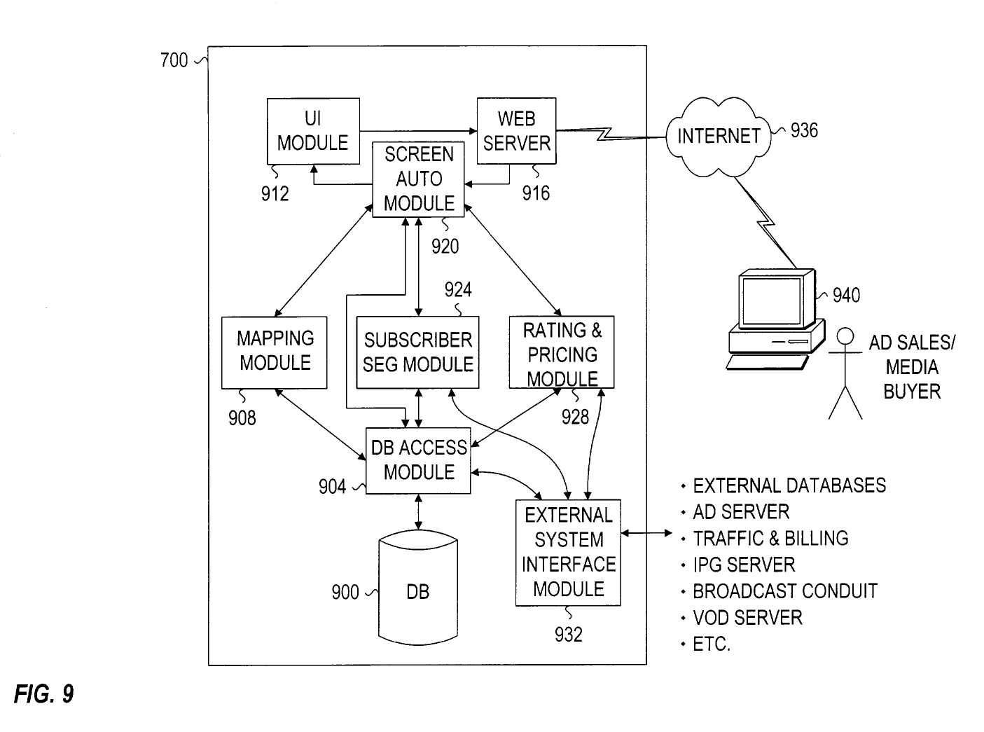

FIG. 9 illustrates an exemplary block diagram of the server side ad management system 700 of FIG. 7. A web server 916 provides the front end to the ad sales/media buyer interface. The use of a web server 916 for this application allows access to anyone with an appropriate web browser and access to the Internet 936. A screen automation module 920 encapsulates the logic behind each of the presentation screens for the ad sales/media buyer interface and manages all of the communication between the web-based interface and the underlying database and processing engines. A UI module 912 renders web pages based on stored configuration data and the output of the screen automation module 920. A mapping module 908 creates geographic maps of selected subscriber areas including demographic boundary identification and market segment assignments. A subscriber segmentation module 924 uses demographic, geographic, and subscriber data to form groups of subscribers that fall into predefined market segments. These groups may be bounded by cable node or cluster boundaries.

A rating and pricing module 928 estimates the effective rating for a particular targeted ad campaign and creates pricing information based on this rating and the provider's basic pricing structure. An ad management database 900 stores all of the subscriber, demographic, market segment, validation, and other data required for the server side ad management system 700. A database access module 904 manages all access to the ad management database 900. The database access module 904 forms appropriate queries based on requests from other system services and coordinates multiple simultaneous requests. An external system interface module 932 provides a single point of connection between the server side ad management system 700 and third party systems such as Traffic and Billing, and geodemographic service providers.

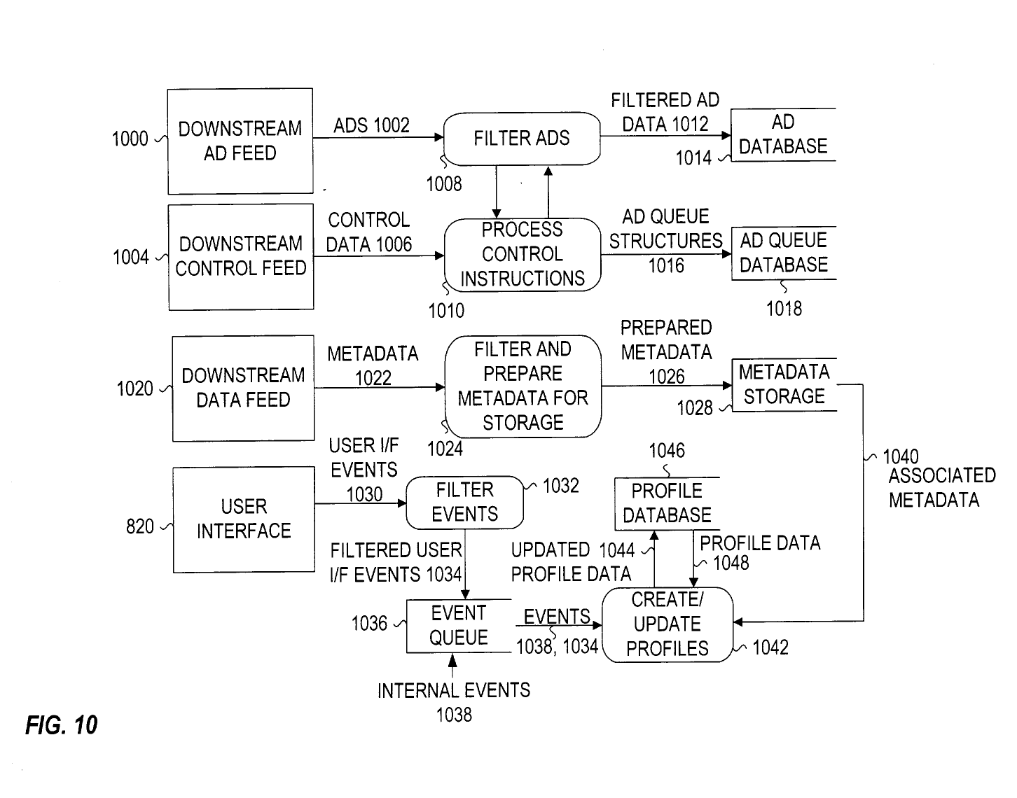

FIG. 10 illustrates an exemplary data flow in a STB PVR (PVR enabled set-top box) for delivering targeted advertising. The STB PVR differentiates individual viewing habits, characterizes the current viewer based on current and historical viewing information, and selects advertising appropriate for the current viewer based on the characterization. Ads 1002 are received by the STB PVR from a downstream ad feed 1000 for storage and subsequent presentation to the viewer. Control data related to ads (ad metadata) 1006 is received by the STB PVR from a downstream control feed 1004. The control data 1006 includes descriptions of the ad content, target audience, encoding attributes, delivery instructions, and contract limitations. The control data 1006 can be created by a number of parties including the ad producer, advertiser, media buyer, network operator, and broadband service provider. The STB PVR can supplement this control data 1006 by adding presentation history and user interaction data.

The ads 1002 are filtered 1008 and the filtered ads 1012 are stored in an ad database 1014. The ad database 1014 resides in a large capacity long-term storage device, such as a hard disk. The control data 1006 is processed 1010 to generate ad queue structures 1016 that are stored in an ad queue database 1018. The ad queue database 1018 also stores the control data (ad metadata) 1006 received from the downstream control feed 1004. The ad queue database 1018 resides in long-term memory, such as a hard disk or flash memory. The system establishes a link that associates the ad metadata 1006 with the related ads 1002 (illustrated as lines between filtering 1008 and processing 1010).

The filtering 1008 determines whether an ad 1002 received from the downstream ad feed 1000 is appropriate for the household by comparing the target audience specified in the ad metadata 1006 with the viewer profiles from a profile database 1046. Ads that are not appropriate for viewers in this household will be discarded. The ad metadata 1006 will either be saved or discarded, depending upon whether the ad was saved or discarded. The processing 1010 manages the ad database 1014 and the ad queue database 1018 by examining the contract limits from the ad metadata 1006 to determine when to purge ads 1002 and ad metadata 1006 from the associated databases 1014, 1018. Additionally, the processing component 1010 updates the ad metadata 1006 based on ad delivery and user interaction.

A downstream data feed 1020 delivers television program/content metadata 1022 to the STB PVR. This metadata 1022 includes the program content, language information, ratings, encoding attributes, networks and air times, delivery requirements, and pricing. The program metadata 1022 can be created by a number of parties including the program producer, media company, network operator, and broadband service provider. The STB PVR can supplement this program metadata 1022 by adding presentation history and user interaction data. The metadata 1022 is filtered and prepared 1024 and the prepared metadata 1026 is stored in metadata storage 1028. The filtering and preparing 1024 makes a determination as to whether to store the program metadata 1022 based on the program air times, network services available by the household, and current system time. The metadata storage database 1028 resides in long-term memory, such as a hard disk or flash memory. It should be noted that the downstream data feed 1020, the filter and prepare metadata component 1024, and the metadata storage 1028 can be replaced by an interface to an electronic program guide/interactive program guide (EPG/IPG) if the EPG/IPG allows access to the program metadata 1022.

A user interface 1050 supplies user events 1030 based on viewer interaction with the remote control and the front panel of the STB PVR. These events 1030 include channel changes, volume changes, and VCR-like controls of the PVR. The events 1030 are time stamped and filtered 1032 to remove events not likely to be relevant to generating a profile of the subscriber. Examples of irrelevant events include channel jumping or surfing. Applicant's co-pending patent applications previously incorporated by reference (but not admitted to be prior art) and identified by docket numbers T702-02, T704-01, and T721-10PCT disclose the use of filters in more detail. Filtered events 1034 are stored in event queue 1036. In addition to filtered user events 1034, the event queue 1036 also stores internal events 1038. The internal events 1038 are events that are generated by the STB PVR, such as end of program, change of day, or change of day part. The event queue 1036 stores the events 1034, 1038 in a sorted list according to the time stamp associate with each event 1034, 1038.

The events 1034, 1038 from the event queue 1036 along with associated program metadata 1040 from the metadata storage 1028 are used to create/update 1042 subscriber profiles 1044. The subscriber profile 1044 is stored in a profile database 1046. If a subscriber profile 1048 (or multiple subscriber profiles) already existed, they 1048 are also used to create (update) 1042 the subscriber profile 1044. A currently stored subscriber profile may be updated if it is determined that current viewing habits are similar to a previous profile. Alternatively, a new profile may be created if it is determined that the current viewing habits are not similar to any of the currently stored profiles.

New profiles are the result of a single viewing session. Updated profiles are the result of multiple viewing sessions being combined into one profile. As a profile accumulates historical viewership data, it becomes a more accurate representation of the viewer. The predominant viewer profiles will accumulate the largest amount of viewing history. When determining whether to save ads in an ad database of limited size, those viewer profiles with the most viewing time will receive the most storage capacity for targeted ads. Currently stored profiles may also be discarded or combined if it is determined that some of the currently stored profiles are similar to each other or that a currently stored profile is outdated (i.e., hasn't been updated in over 1 month).

When an ad insertion opportunity arises, the STB PVR determines whether the current session profile matches any of the historical profiles in the profile database 1046. If a match exists, the match will be used for selecting an appropriate ad. Otherwise, the STB PVR uses the current session profile to select an appropriate ad. After presenting the ad to the viewer, the system updates the ad metadata and transmits an insertion report to the head-end. Applicant's co-pending patent applications previously incorporated by reference (but not admitted to be prior art) and identified by docket numbers T702-00, T702-02, T702-03, T702-04, T702-15, T703-00, T704-00, T704-01, T705-01, T705-02, T705-13, T721-10PCT, T734-10, and T741-10 disclose subscriber profiling, subscriber identification and ad matching in more detail.

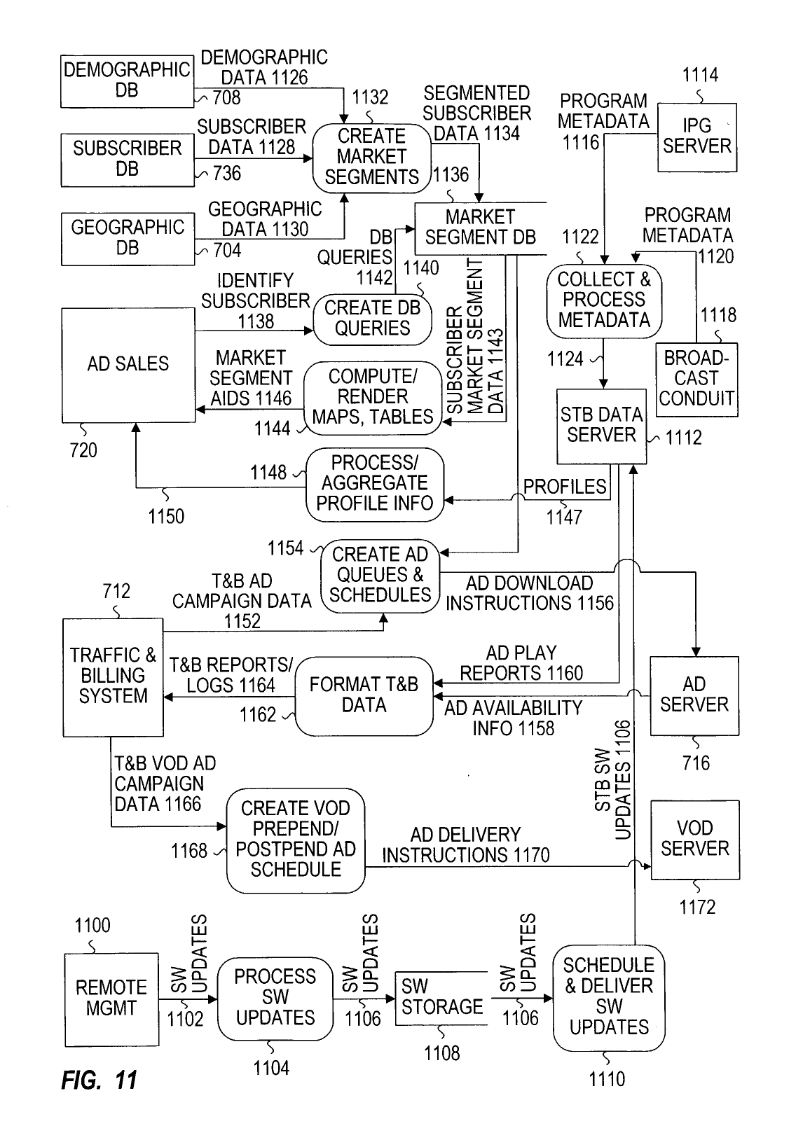

FIG. 11 illustrates an exemplary data flow in an ad management system designed to deliver targeted ads to a STB PVR. This system includes different head-end servers that are used to segment the subscribers, deliver content and metadata to the STB PVR, collect ad insertion results, and collect privacy protected summary data about the subscriber viewing habits. A remote manager 1100 provides a dynamic method of updating software and data files on the STB PVR, including updating the viewer profiling and ad targeting applications. The remote manager 1100 delivers software (SW) updates 1102 that include application enhancements, defect corrections, and data file changes. The SW updates 1102 are processed 1104 and the processed SW updates 1106 are stored in a storage device (SW storage) 1108. The processing 1104 includes accepting new SW builds and the associated data files and determining the updates that need to be delivered to each group of STB PVRs based on network service requirements for that franchise and SW build information. The updated SW and support data files 1106 are maintained on the storage device 1108 until it is time to deliver them to the STB PVRs. The SW updates 1106 are delivered in accordance with a schedule 1110. The schedule 1110 plans delivery of the updated SW 1106 for periods of low television viewership. The SW updates 1106 are sent to a STB data server 1112, which transmits the files to the appropriate STB PVRs.

An IPG Server 1114 delivers interactive program guide information in the form of program metadata 1116. A broadcast conduit 1118 receives program metadata from broadcasters and content providers and deliver the program metadata 1120. The program metadata (from both sources) 1116, 1120 is collected and processed 1122. The processing 1122 includes combining the program metadata from the different sources 1116, 1120 and formatting it for delivery to the STB PVRs. The program metadata 1116, 1120 includes program content, language information, ratings, encoding attributes, networks and air times, delivery requirements and pricing. Combined and formatted program metadata 1124 is sent to the STB data server 1112, which transmits it to the appropriate STB PVRs.

The demographic database 708 contains demographic data 1126 sorted by geographic region. The primary categories of demographic data 1126 include household income, household size, race/ethnicity, and occupation. In order to maintain the subscriber privacy, the database typically maintains data at either a zip+4 or block group level. The subscriber database 736 contains information about the service provider's subscribers 1128. For each subscriber, the database 736 must contain the node on which the household resides and the key to obtain demographic data for that subscriber. The database 736 does not need to maintain privacy related information such as the subscriber name and address. The geographic database 704 maintains detailed maps of the service provider region 1130. The system uses the geographic database 704 to help visualize the market segmentation of the service provider's region of coverage. Data from the demographic database 708, the subscriber database 736, and the geographic database 704 are combined in order to create 1132 market segments for each subscriber (i.e., segmented subscriber data 1134). The segmented subscriber data 1134 is stored in a market segment database 1136.

The ad sales application 720 assists the sales force in selling targeted spots to advertisers. The sales force identifies subscribers 1138 that are is interested in targeting ads to and creates 1140 database (DB) queries 1142. The DB queries 1142 are applied to the market segment database 1136. The results of the queries (subscriber market segmentation data 1143) are used for computing tables and rendering maps 1144. The results of the computation (market segment aids 1146) are displayed to the advertiser (sales force) using the ad sales application 720. The market segment aids 1146 include display of market segment definitions, color-coded market segment maps of the service provider coverage area, and ratings and pricing for targeted advertising based on network, spot time, and ad.

The STB Data Server 1112 generates viewer profiles 1147 based on historical data of television viewing habits (collected metadata). Although the raw data is not exported, the STB PVR can summarize the data and transmit it upstream where it is processed and aggregated 1148 with similar information from other STB PVRs. The process 1148 aggregates similar profiles to create a privacy-protected view of the households by region 1150. The ad sales application 720 uses this data 1150 to help determine the target audience of ads.

The traffic and billing system 712 manages the advertising campaign and controls advertising campaigns for broadcast systems, PVRs, and VoD. The sales force enters requirements for viewership ratings, frequency of viewership by the target audience, and flight information, which indicates the networks and times for displaying the ad (ad campaign 1152). Based on the defined ad campaign data 1152 and the market segment data 1143 from the market segment database 1136 an ad queue and schedule is created 1154. Based on the ad schedule 1154, ad download instructions 1156 are transmitted to the ad server 716. The ad server 716 determines the availability of the ads (ad availability information 1158) identified in the download instructions 1156. The ad server 716 transmits available ads and ad metadata to STB PVRs based on the ad schedule 1154. If the ads are displayed to the subscriber, the STB data server 1112 generates an ad play report 1160. The ad availability information 1158 and the ad play reports 1160 are formatted 1162 to create reports/logs 1164 that are forwarded to the T&B system 712. The traffic and billing system 712 bills the advertiser based on requirements satisfied during the campaign.

The traffic and billing system 712 also allows the advertisers to create a VoD ad campaign 1166. Based on the ad campaign 1166 a prepend/postpend ad schedule component 1168 is created. Based on the schedule 1168, ad delivery instructions 1170 are transmitted to the VoD Server 1172. The VoD Server 1172 stores content to support the VoD service. The VoD Server 1172 uses the ad delivery instructions 1170 to schedule the ads for display at the beginning and end of VoD content. The traffic and billing system 712 tracks the insertion results and bills the advertiser based on the insertions and contract requirements.

As one of ordinary skill in the art would recognize, recorded programming and VoD programming offer the potential that subscribers may fast forward through, or skip advertisements. With the advent of the PVR in any of its various forms that will be discussed in detail below, it is possible for the subscriber to record the programming and play it back in the future (potentially just a few minutes later) and fast forward through, or skip the advertisements. If the ads are fast-forwarded or skipped the value of the ad to the advertiser is diminished (or destroyed) as the subscriber doesn't see the ad or only sees illegible portions of the ad as it is fast-forwarded.

According to one embodiment, the value of the ad can be salvaged by replaying the fast-forwarding ad with an alternative shortened version of the ad. The alternative ad may be generated from the fast-forwarding ad or it may be a separate ad. The alternative ad may be a portion of video of the fast-forwarding ad (i.e., the first 2 seconds, first second and last second), a single image, a combination of still image and video, a modification of video, still image or combination thereof (i.e., addition of graphics), or not be based on the fast forwarding ad at all. The alternative ad may be displayed in place of the fast-forwarding ad or in conjunction with the fast-forwarding ad (i.e., split screen, picture-in-picture). The alternative ad may be generated from the ad by applying rules that are either specific to the ad or are general and can be used for generating a replacement for any fast-forwarding ad.

The alternative ads are in effect another form of avail. According to one embodiment, this feature would be available to any advertiser as long as they either defined the rules to apply to the ad, identified a separate ad to play in the event of a fast-forward, or generated the ad in such a fashion that generic rules could generate the alternative ad. According to another embodiment, the advertisers would have to pay a premium for this protection to their advertising value (i.e., pay for these new avails). According to another embodiment, alternative advertisers could purchase the avails that become available when ads are fast-forwarded. For example, Coke could pay to insert a shortened Coke ad in place of a fast-forwarding Pepsi ad. It should be noted that the display of alterative ads is not limited to fast-forward events but can also occur during skip, rewind or other VCR type functions that are often replayed to as “trick-play”. Applicants ADhance™ technology handles the displaying (and generation when applicable) of the alternative ads during trick-play events and is described in applicants' co-pending patent application previously incorporated by reference (but not admitted to be prior art) and identified by docket number T738-10.

According to one embodiment of the invention, the ads selected from the ad queue (or UAQ) stored in the PVR is behavioral in nature. That is, depending on how the subscriber reacts (or interacts) to the ads presented to them determines what ads are displayed to the subscriber (behavioral targeting). The reactions (or interactions) to the ads may include viewing the ads, skipping the ads, fast forwarding the ads, changing the channel, viewing an alternative ad, requesting more information about the product, service or company in the ad, or other reactions that would be known.

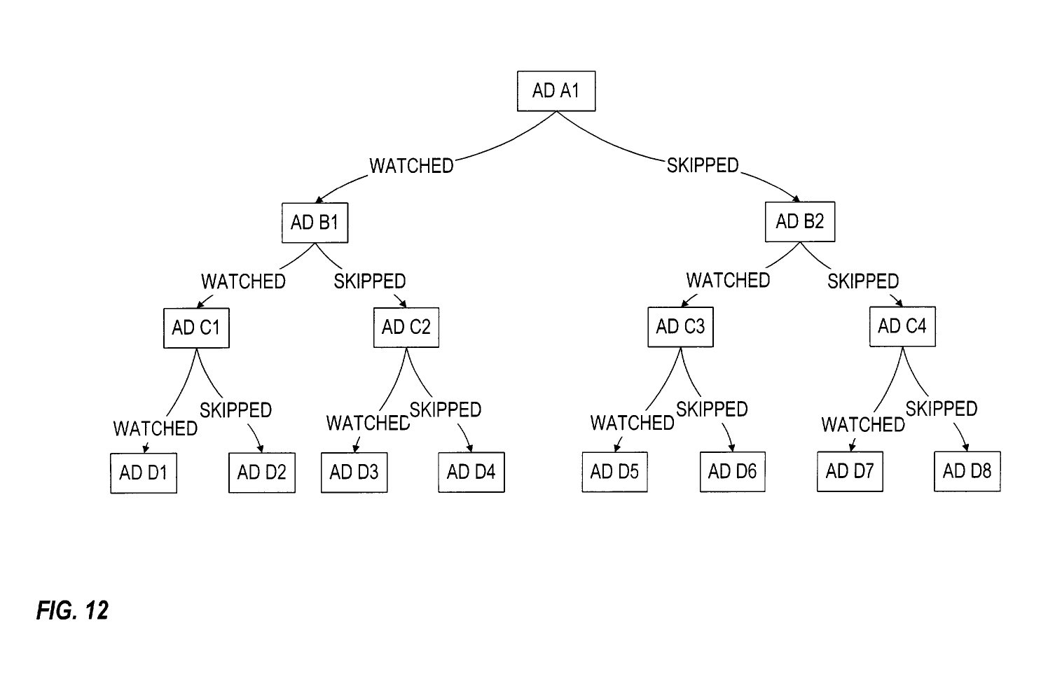

According to one embodiment, the behavioral aspect is included in the ad queue (or UAQ) as some type of tree structure defined therein. FIG. 12 illustrates an exemplary embodiment of a tree structure that could be embedded in the ad queue in some fashion. As illustrated, based on whether the subscriber watches or skips each ad determines the next ad that is displayed to the subscriber. For example, if the subscriber watches ad A1 the next ad received is ad B1 while if the subscriber skipped the ad the next ad presented is B2. The next ad selected from the ad queue (and presented to the subscriber) if the subscriber views the ad may be have a common parameter with the viewed ad. The common parameters may include, but are not limited to, similar intended market demographics, shared product/service type, same ad type, same ad genre, same company, similar features, and other parameters that would be obvious to one of ordinary skill in the art. The next ad selected if the ad is skipped may have different parameters than those for the skipped ad.

For example, if the viewer watched an ad for a Ford SUV (ad A1) they might be presented an ad for a Ford sedan (ad B1) as both ads are Ford related. If the viewer skipped the SUV ad (ad A1) they may be presented with an ad for McDonalds (ad B2) as these two don't have similar parameters (at least not obvious parameters). If the subscriber viewed ad B1, they may be presented with an ad for a Ford truck (ad C1) as all the ads (A1, B1, C1) are Ford related. If the subscriber did not watch the sedan ad (ad B1) they may presented with an ad for a Dodge SUV (ad C2), as the ad is SUV related (which appears to have been determined be acceptable in ad A1) but not Ford related (which appears to have not been determined to be acceptable in ad B1). As illustrated each ad in the tree structure is different. However it should be noted that this is not the case that the same ad may be displayed at different times in the tree structure. For example, it is possible that ads C1 and D8 are the same and that you get to that ad based on two completely separate branches in the tree. The different parameters applied at each branch just happened to eventually lead to the same ad.

As would be obvious the choice of which parameter to use or not use for the next ad is subjective. That is, the parameter that the next ad is based on (related/not related to) may be specific ad, ad type, ad genre, product, service, company, other criteria, or a combination thereof. The parameter used will depend at least some subset of criteria used by the advertisers in selecting their ad campaign and criteria used by the delivery network in generating the ad queue (or UAQ). The criteria used by the delivery network may include, but is not limited to, subscriber preferences, market segment associated with the subscriber, previous interactions of the subscriber, subscriber viewing habits, or some combination thereof.

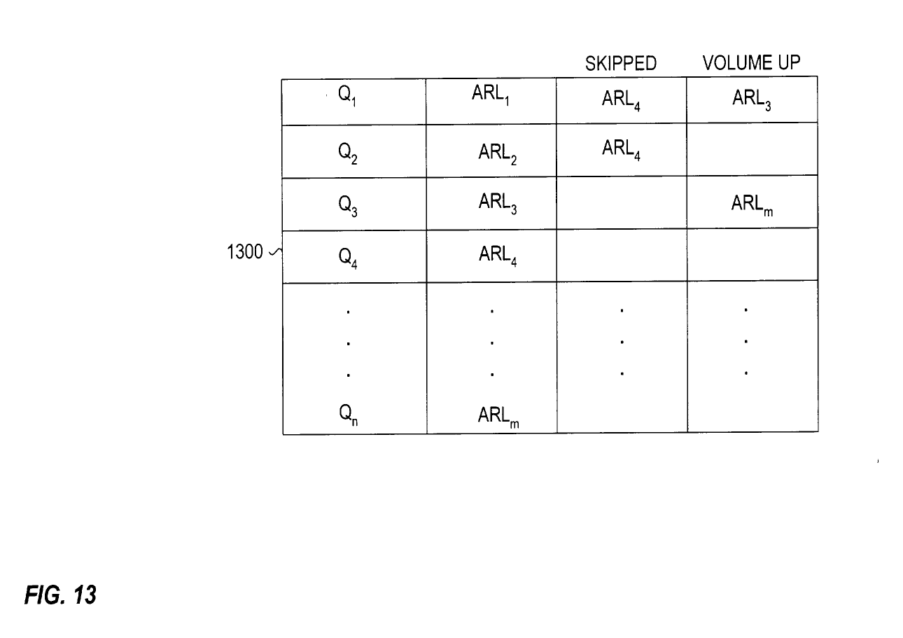

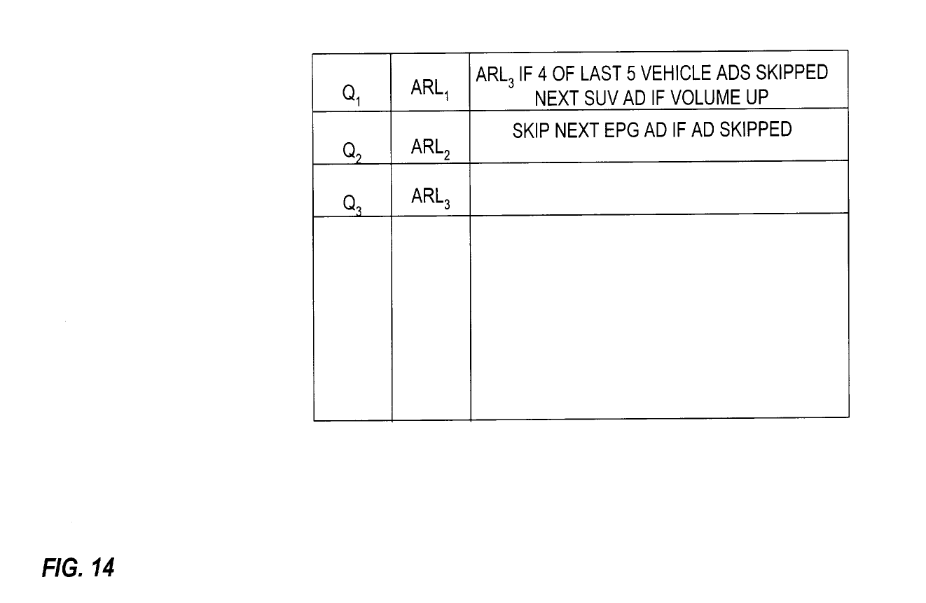

As one skilled in the art would recognize, the tree structure would not be limited to view and skip, but could also include fast-forward, change channel, turn up/down volume, or other reactions that would be obvious to one of ordinary skill in the art. The tree structure defined in the ad queue may be tight or loose. A tight ad tree would be one that specified the next ad in the queue based on a specific action. FIG. 13 illustrates an exemplary ad queue (or UAQ) 1300, in which the ad queue has specific links for the next ad to select if the previous ad is skipped (insinuating not interested) or the volume is turned up during the ad (insinuating interested). As illustrated, the ads in the queue are ordered ARL1-ARL4 respectively. If ARL1 is skipped the next ad in the queue will become ARL4, while if the volume is turned up on ARL1 the next ad in the queue will be ARL3. A loose ad tree would be one in which the next ad is not necessarily selected based on a single action. That is, the next ad may be based on a multitude of actions, or the next ad may be based on the which is the next ad with a certain feature. FIG. 14 illustrates an exemplary ad queue with a loose tree structure. As illustrated, the ad stored in ARL3 will follow ARL1 in the queue if four out of the last 5 vehicle ads were skipped. The next SUV ad will be displayed if the volume was turned up during the ARL1 ad. If the ARL2 ad is skipped the next EPG ad in the queue will be skipped. It should be noted that FIGS. 13 and 14 are in no way intended to limit the scope of the invention, as there are multiple other ad queues with loose and tight tree structures that would be well within the scope of the current invention.

As one skilled in the art would recognize, the tree structure need not make a determination after each ad but may make a determination after a set of ads. That is, ad A1 in FIG. 12 may in fact be a series of ads and the next series of ads to be selected from the queue is dependent on the subscriber interactions to the first set (A1). The decision may be based on whether a majority of the ads where watched or skipped, or whether a certain number were watched or skipped. For example, if A1 consisted on 11 ads and 6 were watched the B1 set would be selected if the decision was based on a majority. If the ads were a set of ads, there could be more criteria than simply watched or skipped. For example the criteria could be what percentage of ads were watched and there could be 4 separate paths (0-25%, 25-50%, 50-75%, and 75-100%).

As noted above, it is possible that a single ad may be displayed based on totally separate branches (i.e., ads C1 and D8). For example referring to FIG. 13, it is possible that ARL4 is being selected because it is the fourth ad in the queue 1300 or because it is the 3 ad in the queue 1300 (ARL2 was skipped and it was then selected it as the next ad). However, the ad queue 1300 simply decides on the next ad based on the subscribers interaction to that ad. Thus, in a preferred embodiment, the selection of the next ad in the tree (ad queue) should not be limited to simply the subscriber interaction to that ad but should be based on a track record of decisions. There are numerous ways in which some aspect of the subscribers track record of interactions with ads could be incorporated in the ad queue 1300. It is intended that the current invention covers the various manners in which this could be accomplished. As should be obvious, the more ads that are monitored, the more accurate the selection of the next ad will be, as there will be more data to base the determination on. According to a preferred embodiment, the interactions to the ads will be monitored and processed so that there is a composite description of the subscriber ad preferences to use in making the determination as to which ad to display next.

According to one embodiment, the decsion tree is not associated with the ad queue (or UAQ). Rather, the ad queue may be modified based on the actions of the subscriber. That is, the PVR may learn about the subscriber and modify the UAQ to be more in line with the subscriber. The modification of the UAQ may be based on rules associated with the subscriber's actions. The rules may be rules provided by the advertisers in the development of the UAQ, general rules applied to all UAQs, rules that are based on a profile of the subscriber developed by the PVR, other types of rules now known or later developed, or some combination thereof. The rules may modify the order of the UAQ, may remove ads from the UAQ, may add ads to the UAQ, may add limitations (preferences/restrictions/links) to the UAQ, or make other modifications that would be obvious to those of ordinary skill in the art. Examples of ads that may be removed or added include, but are not limited to specific ads (i.e., Britney Spears Pepsi ad), specific company ads (i.e., Pepsi), ads for a particular product type (i.e., beer), specific type of ads (i.e., EPG), or specific genre of ad (i.e., funny ads). The rules may be applied after each ad, after each specific action a subscriber takes while viewing an ad (i.e., skip or fast forward ad, change channel, raise or lower volume), at fixed intervals (i.e., once a day), when the PVR determines that it is in order, or some combination thereof.

The invention has been described with specific emphasis on digital video. However, the invention is not limited thereto and may be applied to audio, streaming media and other advertisement media that would be known to those skilled in the art. In fact, this application has defined some alternative audio advertisements as they relate to the video counterparts but could applied to simply audio. Moreover, this application has concentrated on PVRs but the invention is not limited thereto. In fact, the invention to be applied to any prerecorded media. For example, if a subscriber attempted to fast forward through the previews on a movie rental they may be presented with an alternative preview.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

What is claimed is:

1. A method for managing presentation of ads to a subscriber based on subscriber interactions with previous ads, the method comprising:
presenting an ad to the subscriber;
monitoring the subscribers interactions to the ad; and
determining which ad to display to the subscriber next based on said monitoring.

2. The method of claim 1, wherein said monitoring includes monitoring if the subscriber views or skips the ad.

3. The method of claim 2, wherein said determining selects a first ad if the subscriber views the ad and a second ad if the subscriber skips the ad.

4. The method of claim 3, wherein the first ad is a first ad type and the second ad is a second ad type.

5. The method of claim 4, wherein the first ad type and the second ad type are selected from at least some subset of programming advertisements, EPG advertisements, product placement advertisements, overlay advertisements, bug advertisements, banner advertisements, recorded advertisements, VoD advertisements, and alternative advertisements.

6. The method of claim 3, wherein the first ad is a first ad genre and the second ad is a second ad genre.

7. The method of claim 6, wherein the first ad genre and the second ad genre are selected from at least some subset of humorous, serious, emotional, action, and musical.

8. The method of claim 1, wherein said presenting includes presenting at least some subset of programming advertisements, EPG advertisements, product placement advertisements, overlay advertisements, bug advertisements, banner advertisements, recorded advertisements, VoD advertisements, and alternative advertisements.

9. The method of claim 1, further comprising receiving programming; and
detecting avails with the programming; and
wherein said determining includes determining which ad to display next based on said monitoring and said detecting.

10. The method of claim 1, wherein said monitoring includes
recording the subscriber interactions; and
processing the subscriber interactions to determine trends.

11. The method of claim 10, wherein the trends include preferences or dislikes for at least some subset of different ads, ad genres, ad types, ads for particular products; ads for particular services, ads for particular companies, and ads for particular industries.

12. The method of claim 11, wherein said determining selects the next ad to display because it is preferred by the subscriber.

13. The method of claim 11, wherein said determining selects the next ad to display because the ad scheduled to be displayed is disliked by the subscriber.

14. The method of claim 10, wherein said determining includes modifying an ad queue that identifies an order for ads to be displayed based on the trends.

15. The method of claim 1, wherein the ads are targeted.

16. The method of claim 15, wherein the ads are targeted based on subscriber type.

17. The method of claim 15, wherein the subscriber may be associated with a different subscriber type based on said monitoring.

18. The method of claim 17, wherein the subscriber type is associated with market segments.

19. The method of claim 17, wherein the subscriber type is a profile identifying various traits about the subscriber.

20. The method of claim 19, wherein the various traits include at least some subset of demographics, viewing preferences, purchasing preferences, and interests.

21. The method of claim 1, wherein said determining includes selecting the ad that is next in an ad queue based on said monitoring.

22. The method of claim 1, wherein the subscriber interactions include at least some subset of view, skip, fast-forward, change channel, raise volume, lower volume, select more details, and pause.

23. A system for managing presentation of ads to a subscriber based on subscriber interactions with previous ads, the system comprising: means for presenting an ad to the subscriber;
means for monitoring the subscribers interactions to the ad; and
means for determining which ad to display to the subscriber next responsive to said means for monitoring.

24. The system of claim 23, further comprising
means for receiving programming; and
means for detecting avails with the programming; and
wherein said means for determining determines which ad to display next responsive to said means for monitoring and said means for detecting.

25. The system of claim 23, wherein said means for monitoring includes
means for recording the subscriber interactions; and
means for processing the subscriber interactions to determine trends.

26. A computer program embodied on a computer-readable medium for managing presentation of ads to a subscriber based on subscriber interactions with previous ads, the computer program comprising:
a source code segment for presenting an ad to the subscriber;
a source code segment for monitoring the subscribers interactions to the ad; and
a source code segment for determining which ad to display to the subscriber next responsive to said means for monitoring.

27. The computer program of claim 26, further comprising
a source code segment for receiving programming; and
a source code segment for detecting avails with the programming; and
wherein said means for determining determines which ad to display next responsive to said source code segment for monitoring and said source code segment for detecting.

28. The computer program of claim 26, wherein said source code segment for monitoring includes
a source code segment for recording the subscriber interactions; and
a source code segment for processing the subscriber interactions to determine trends.

29. A method for managing the display of advertisement to subscribers based on subscribers interactions to previous advertisements, the method comprising
monitoring the subscribers interaction with an advertisement;
detecting a next avail;
querying an ad queue to determine which advertisement should be inserted in the next avail, wherein the ad queue includes an ordered list of ads and links that may modify the order based on monitored interactions;
retrieving the advertisement;
inserting the advertisement in the avail; and
delivering the advertisement to the subscriber.

30. The method of claim 29, wherein the subscribers interactions include at least some subset of view, skip, fast-forward, change channel, raise volume, lower volume, select more details, and pause.

31. The method of claim 29, wherein the links are tight links that select a specific next ad in the ad queue based on a specific subscriber interaction.

32. The method of claim 29, wherein the links are loose links.

33. The method of claim 32, wherein the loose links selects a specific ad based on a combination of criteria.

34. The method of claim 32, wherein the loose links select a type of ad based on some criteria.

35. The method of claim 29, wherein the ad queue may include multiple ad types.

36. The method of claim 35, wherein the ad types include at least some subset of programming advertisements, EPG advertisements, product placement advertisements, overlay advertisements, bug advertisements, banner advertisements, recorded advertisements, VoD advertisements, and alternative advertisements.

37. The method of claim 36, wherein the ad queue is a universal ad queue that manages the order of and links between all ad types.

38. A system for managing the display of advertisement to subscribers based on subscribers interactions to previous advertisements, the system comprising
means for monitoring the subscribers interaction with an advertisement;
means for detecting a next avail;
means for querying an ad queue to determine which advertisement should be inserted in the next avail, wherein the ad queue includes an ordered list of ads and links that may modify the order based on monitored interactions;
means for retrieving the advertisement;
means for inserting the advertisement in the avail; and
means for delivering the advertisement to the subscriber.

39. A computer program embodied on a computer readable medium for managing the display of advertisement to subscribers based on subscribers interactions to previous advertisements, the computer program comprising
source code for monitoring the subscribers interaction with an advertisement;
source code for detecting a next avail;
source code for querying an ad queue to determine which advertisement should be inserted in the next avail, wherein the ad queue includes an ordered list of ads and links that may modify the order based on monitored interactions;
source code for retrieving the advertisement;
source code for inserting the advertisement in the avail; and
source code for delivering the advertisement to the subscriber.

40. A personal video recorder for presenting advertisements to a subscriber, the personal video recorder comprising:
an interface for receiving video programming;
an ad queue containing an ordered list of advertisements;
a detector for detecting avails within the video programming;
a monitor for monitoring subscriber interactions;
a selector for selecting an advertisement from the ad queue for insertion in the avail responsive to said monitor;
an inserter for inserting the advertisement into the avail; and
a modulator for modulating the video programming with the advertisement inserted therein to the subscriber.

41. The personal video recorder of claim 40, further comprising a database containing a plurality of advertisements, wherein at least a subset of the plurality of advertisements are listed in the ad queue.

42. The personal video recorder of claim 41, wherein the advertisements include at least some combination of programming advertisements, EPG advertisements, product placement advertisements, overlay advertisements, bug advertisements, banner advertisements, recorded advertisements, VoD advertisements, and alternative advertisements.

43. The personal video recorder of claim 40, wherein the ad queue is stored in a database.

44. The personal video recorder of claim 40, wherein the ad queue identifies where the advertisements are located.

45. The personal video recorder of claim 40, wherein the universal ad queue includes links associated with specific subscriber actions that may modify the order of the ads in the ad queue.

46. The personal video recorder of claim 40, wherein the universal ad queue includes links between various advertisement types.

47. The personal video recorder of claim 40, wherein at least some subset of the advertisements identified in the universal ad queue are targeted advertisements.

48. The personal video recorder of claim 40, further comprising a processor for modifying the ad queue responsive to said monitor.
